(19) United States
(12) Patent Application Publication
(10) Pub. No.: US 2005/0156715 A1
(43) Pub. Date: Jul. 21, 2005

(54) Method and system for interfacing with mobile telemetry devices

(76) Inventors: Jie Zou, Brandon, MS (US); Vamsi Uppalapati, Madison, MS (US); Michael L. Greer, Bogue Chitto, MS (US); Norman L. Goering JR., Brandon, MS (US)

Correspondence Address: MCI, INC;TECHNOLOGY LAW DEPARTMENT, 1133 19TH STREET NW, 10TH FLOOR, WASHINGTON, DC, 20036, US

(21) Appl. No.: 10/758,930

(22) Filed: Jan. 16, 2004

(51) Int. Cl. B60R 25/10

(52) U.S. Cl. 340/426.19; 340/539.13; 340/531; 340/825.49; 340/426.15

(57) ABSTRACT

An interface is provided for managing a plurality of tracked objects, each tracked object associated with a corresponding telemetry device. A request is received from a web browser for at least one action to be performed by the telemetry device. A message including information indicating the at least one action is transmitted, to the corresponding telemetry device. The web browser is configured to display at least one geographical map indication of at least one location of each tracked object.

### FIELD OF THE INVENTION

The present invention relates to data communications, and more particularly, to interfacing with mobile telemetry devices for fleet and asset management.

### BACKGROUND OF THE INVENTION

Modern wireless networks, such as paging systems, can readily be configured to offer a variety of telemetry services, notably fleet and asset management. The management of vehicles within a fleet as well as assets involves obtaining information, generally in real-time, about the location and movement of these objects. The fleet manager utilizes this information to maximize use of fleet resources. With the advent of the Global Positioning System (GPS) supported by a constellation of satellites, a vehicle may determine its location with great accuracy and convenience if no obstruction exists between the GPS receiver within the vehicle and the satellites. Additionally, in recognition of the utility of real-time location of vehicles, governmental bodies have begun to impose strict requirements for determining position information of emergency 911 callers. Therefore, with the impetus stemming from competitive and regulatory forces, service providers seek to offer an efficient, cost-effective fleet and asset management service with robust capability by effectively integrating GPS technology with wireless networks so as to minimize bandwidth in the exchange of telemetry data.

FIG. 23 shows a diagram of a conventional wireless network in an autonomous GPS environment. As shown, a wireless network 2301 communicates with vehicles 2303 to track the location of these vehicles 2303 within the coverage area of the wireless network 2301. Each of the vehicles 2303 employ a GPS device 2305 that communicates with a constellation of satellites 2307. These satellites 2307 transmit very low power interference and jamming resistant signals received by the GPS receivers 2305. At any point on Earth, a GPS device 2305 is able to receive signals from multiple satellites (e.g., 6 to 11).

Specifically, a GPS device 2305 may determine three-dimensional geolocation from signals obtained from at least four satellites. Measurements from satellite tracking and monitoring stations located around the world are incorporated into orbital models for each satellite to compute precise orbital or clock data. GPS signals are transmitted over two spread spectrum microwave carrier signals that are shared by all of the GPS satellites 2307. The device 2305 must be able to identify the signals from at least four satellites 2307, decode the ephemeris and clock data, determine the pseudo range for each satellite 2307, and compute the position of the receiving antenna. The time required to acquire a position depends on several factors including the number of receiving channels, processing power of the receiving device, and strength of the satellite signals.

The above arrangement, as an autonomous GPS environment, has a number of drawbacks that can hinder its effectiveness as a fleet management system. Because the GPS device 2305 must obtain all of the ephemeris data from the satellite signals, weak signals can be problematic. A building location or a location in any area that does not have clear view of the satellite constellation 2307 can prevent the GPS device 2305 from determining its geolocation. Also, cold start acquisition may consume a few seconds to as much as a few minutes, which is a significant delay for the device's ability to log positional information and evaluate its position against pre-configured alert conditions.

The vehicles 2303 then need to transmit the location information to the wireless network 2301. These transmissions can consume large amounts of bandwidth of the wireless network 2301 if the location information is continually transmitted without attention to the polling scheme and the underlying transmission protocol used to transport such data. Additionally, a user interfacing with the device remotely may request information that may require significant download time for response, e.g., if the user is requesting the information via a web browser through, e.g., the Internet (e.g., the response to the request may involve an extremely large amount of data). An exemplary user may desire a display of a graphical map of the area currently surrounding the location of the device. Additionally, the user may desire that the display include a graphical indicator to indicate the current position or a status associated with the device. Also, the user may desire a display to enable the user to configure the device, control an entity associated with the device (e.g., a vehicle, or a fleet of vehicles for multiple devices) or to request and receive reports of the device status, or to graphically handle management issues related to the device.

An amount of information needed for such graphical display may involve transmission of very large amounts of data for handling at the user's machine, as well as massive programming efforts to implement code for handling various types of requests that the user may make. If a user has to wait several minutes for download of the data required for a graphical map screen to be painted on his/her display device, the user may become frustrated, or may be unable to quickly respond, e.g., to a time-critical need that may be indicated by information communicated by the device. Additionally, a user may not wish to expend resources on programmer time and effort, and storage capacity, to support overwhelming amounts of code for implementation of various features for a graphical interface.

Therefore, there is a need for a user interface for a fleet and asset management system that provides a graphical display for a user of features of the system such as location maps, status indicators, and user configuration of communication with the device in a timely and efficient manner.

### SUMMARY OF THE INVENTION

These and other needs are addressed by the present invention, in which an approach for tracking mobile telemetry devices over a two-way wireless network in support of fleet and asset management is provided. Each of the telemetry devices can operate in multiple Global Positioning System (GPS) modes: autonomous GPS mode, and mobile-based assisted-GPS (A-GPS) mode. In autonomous mode, GPS data may be acquired with no assistance data provided by the wireless network. When a telemetry device is within the network coverage area of the wireless network, the telemetry device operates in the A-GPS mode, in which assistance data is supplied by an A-GPS server resident within a Network Operations Center (NOC). The assistance data can include ephemeris data, approximate location, time, and other GPS data needed to obtain location quickly or in obstructed view locations (in building, wooded areas, etc.). The NOC also includes a presentation server that executes a number of applications in support of fleet and asset management: a database application for maintaining configuration information of the telemetry devices and the user account information; and a web-based application for serving maps, presenting user interfaces to manage and control user administration, and the device configuration.

A graphical user interface enables a user to communicate with a single device or multiple devices by timely display and update of geographical map screens which indicate a current location and status information of the telemetry device (current as of a last transmission from the telemetry device of location data). The user may additionally configure the device for scheduling of data to be sent from the device, and for controlling the device and an entity associated with the device (e.g., a vehicle or a fleet of vehicles for multiple devices). Reports regarding status of the device may be requested and displayed in a timely and efficient manner, and control commands which may be sent from the user to the device may be received by the device quickly and efficiently. In order to minimize the initial download time of an applet to a web browser, e.g., many map-processing functions may be handled on a server, resulting in all files for, e.g., an applet to be efficiently wrapped in a more compact jar file for download by the user. Additionally, by using the features of Java Reflection, the names of all members of a Java object class can be dynamically identified so that the proper handling of an object can be initialized accordingly as needed, thus minimizing programmer/developer effort.

According to one aspect of the present invention, a method for managing a plurality of tracked objects is disclosed. Each tracked object is associated with a corresponding telemetry device. The method includes receiving, from a web browser, a request for at least one action to be performed by the at least one corresponding telemetry device. The method also includes transmitting, to the at least one corresponding telemetry device, a message including information indicating the at least one action, wherein the web browser is configured to display at least one geographical map indication of at least one location of each tracked object.

According to another aspect of the present invention, a display device for managing a plurality of tracked objects is disclosed. Each tracked object is associated with a corresponding telemetry device. The display device includes a web browser configured to process a request for at least one action to be performed by the at least one corresponding telemetry device, to display at least one geographical map indication of at least one location of each tracked object, and to transmit information for inclusion in a message, for transmission to the corresponding telemetry device, the message including information indicating the at least one action.

According to another aspect of the present invention, a computer-readable medium carrying one or more sequences of one or more instructions for managing a plurality of tracked objects is disclosed. Each tracked object is associated with a corresponding telemetry device. The one or more sequences of one or more instructions include instructions which, when executed by one or more processors, cause the one or more processors to perform the steps of receiving, from a web browser, a request for at least one action to be performed by the at least one corresponding telemetry device; and transmitting, to the at least one corresponding telemetry device, a message including information indicating the at least one action, wherein the web browser is configured to display at least one geographical map indication of at least one location of each tracked object.

According to another aspect of the present invention, a method for managing a plurality of tracked objects is disclosed. Each tracked object is associated with a corresponding telemetry device. The method includes transmitting, to a user, display information for displaying interactive elements on a display device. The method also includes receiving, from the user, information associated with at least one status of at least one of the tracked objects. The method also includes transmitting, to the telemetry device corresponding to the at least one tracked object, a message including the information associated with the at least one status, wherein the at least one status is at least one of monitored and controlled by at least one processor included in the telemetry device corresponding to the at least one tracked object, and wherein the display device is configured to display at least one geographical map indication of at least one location of each tracked object.

According to yet another aspect of the present invention, an apparatus for managing a plurality of tracked objects, each tracked object associated with a corresponding telemetry device, is disclosed. The apparatus includes means for transmitting, to a user, display information for displaying interactive elements on a display device. The apparatus also includes means for receiving, from the user, information associated with at least one status of at least one of the tracked objects. The apparatus also includes means for transmitting, to the telemetry device corresponding to the at least one tracked object, a message including the information associated with the at least one status, wherein the at least one status is at least one of monitored and controlled by at least one processor included in the telemetry device corresponding to the at least one tracked object, and wherein the display device is configured to display at least one geographical map indication of at least one location of each tracked object.

Still other aspects, features, and advantages consistent with the present invention are readily apparent from the following detailed description, simply by illustrating a number of particular embodiments and implementations, including the best mode contemplated for carrying out the present invention. Methods, systems, and articles of manufacture consistent with the present invention are also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a fleet and asset tracking system, according to an embodiment of the present invention;

FIG. 2 is a diagram of a telemetry device used in the system of FIG. 1, according to an embodiment of the present invention;

FIG. 3 is a diagram of a Network Operations Center (NOC) in the system of FIG. 1, according to an embodiment of the present invention;

FIG. 4 is a diagram of the formats of protocol messages used in the system of FIG. 1;

FIG. 5 is a diagram of the format of a Wireless Protocol (WP) message used in the system of FIG. 1;

FIG. 6 is a diagram of the format of a batched Wireless Protocol (WP) message used in the system of FIG. 1;

FIG. 7 is a diagram of a Network Operations Center (NOC) in the system of FIG. 1, according to an embodiment of the present invention;

FIG. 8 is a diagram of a fleet and asset management system with end-to-end encryption, according to an embodiment of the present invention;

FIG. 9 is a diagram of a fleet and asset management system with end-to-end encryption in an enterprise environment, according to an embodiment of the present invention;

FIG. 10 is a diagram of the telemetry device of FIG. 2a deployed within the vehicle, according to an embodiment of the present invention;

FIG. 11 is a diagram of an exemplary arrangement of components for configuring a web browser for fleet or asset tracking and management according to an embodiment of the present invention;

FIG. 12a is a graphical screen depiction of a listing of classes of an exemplary Java class hierarchy for an exemplary user interface system server, according to an embodiment of the present invention;

FIG. 12b is a graphical screen depiction of a listing of classes of an exemplary applet class hierarchy for an exemplary user interface client, according to an embodiment of the present invention;

FIG. 12c is a graphical screen depiction of an exemplary jar file for the applets shown in FIG. 12b, according to an embodiment of the present invention;

FIG. 12d is a graphical screen depiction of a listing of JavaBean classes for information exchange between server and client for an exemplary user interface system, according to an embodiment of the present invention;

FIG. 13 is a graphical screen depiction of a map of a provider's wireless coverage area, according to an embodiment of the present invention;

FIG. 14a is a graphical screen depiction of a map with device location points in pan mode, according to an embodiment of the present invention;

FIG. 14b is a graphical screen depiction of a map with device location points showing a selected area to be zoomed in, according to an embodiment of the present invention;

FIG. 14c is a graphical screen depiction of a map with device location points showing the selected zoom in area after zooming in, according to an embodiment of the present invention;

FIG. 14d is a graphical screen depiction of a map with device location points showing a zoom level, according to an embodiment of the present invention;

FIG. 14e is a graphical screen depiction of a map with device location points zoomed directly to a greater zoom level from the zoom level of the map of FIG. 14d, according to an embodiment of the present invention;

FIG. 15a is a graphical screen depiction showing a pop up menu for a vehicle, according to an embodiment of the present invention;

FIG. 15b is a graphical screen depiction showing a pop up menu for a fleet, according to an embodiment of the present invention;

FIG. 15c is a graphical screen depiction showing a pop up menu for a GeoFence group, according to an embodiment of the present invention;

FIG. 15d is a graphical screen depiction showing a pop up menu for a vehicle under a GeoFence group, according to an embodiment of the present invention;

FIG. 15e is a graphical screen depiction showing a pop up menu for a map with vehicle location points, according to an embodiment of the present invention;

FIG. 15f is a graphical screen depiction showing a pop up menu for a map with both vehicle location points and landmarks, according to an embodiment of the present invention;

FIG. 15g is a graphical screen depiction showing a pop up menu available upon a mouse right click on a vehicle icon on the map, according to an embodiment of the present invention;

FIG. 15h is a graphical screen depiction showing a pop up menu available upon a mouse right click on a landmark icon on the map, according to an embodiment of the present invention;

FIG. 15i is a graphical screen depiction showing a pop up menu available upon a mouse right click on a GeoFence object on the map, according to an embodiment of the present invention;

FIG. 16a is a graphical screen depiction of a form displayed to collect address information for locating vehicles nearest to the address, according to an embodiment of the present invention;

FIG. 16b is a graphical screen depiction of a form displayed to collect address information for specifying a landmark, according to an embodiment of the present invention;

FIG. 16c is a graphical screen depiction of a form displayed to collect information for initiating a trail query for tracking selected vehicles, according to an embodiment of the present invention;

FIG. 16d is a graphical screen depiction of a form displayed to collect information indicating a user preference for display of a map on the screen, according to an embodiment of the present invention;

FIG. 16e is a graphical screen depiction of a form displayed to collect information indicating a user's comment for a map to be printed, according to an embodiment of the present invention;

FIG. 16f is a graphical screen depiction of a map plus the comment provided in FIG. 16e in PDF format, according to an embodiment of the present invention;

FIG. 17a is a graphical screen depiction of a form displayed to collect information indicating a user preference for information to be included in a GeoFence alert report, according to an embodiment of the present invention;

FIG. 17b is a graphical screen depiction of a form displayed to collect information indicating a user preference for information to be included in a speeding report, according to an embodiment of the present invention;

FIG. 17c is a graphical screen depiction of a form displaying available reports, according to an embodiment of the present invention;

FIG. 17d is a graphical screen depiction of a form displayed to collect information indicating a user preference for information to be included in a custom report, according to an embodiment of the present invention;

FIG. 18a is a graphical screen depiction of a form displayed to enable a user to assign vehicles to fleets, according to an embodiment of the present invention;

FIG. 18b is a graphical screen depiction of a form displayed to enable a manager to create users and set permissions, according to an embodiment of the present invention;

FIG. 18c is a graphical screen depiction of a form displayed to enable a manager to manage vehicles, according to an embodiment of the present invention;

FIG. 18d is a graphical screen depiction of a form displayed to enable a user to request retrieval of data from a device, according to an embodiment of the present invention;

FIG. 18e is a graphical screen depiction of a form displayed to enable a user to manage templates, according to an embodiment of the present invention;

FIG. 19a is a graphical screen depiction of user help information, according to an embodiment of the present invention;

FIG. 19b is a graphical screen depiction of contact information, according to an embodiment of the present invention;

FIG. 20a is a graphical screen depiction of a form displayed to collect information indicating a user preference for information to be collected regarding alerts, according to an embodiment of the present invention;

FIG. 20b is a graphical screen depiction of a form displayed to collect information indicating a user preference for information to be collected regarding alerts, according to an embodiment of the present invention;

FIG. 20c is a graphical screen depiction of a form displayed to collect information indicating a user preference for information to be collected regarding alerts associated with digital and analog inputs, according to an embodiment of the present invention;

FIG. 20d is a graphical screen depiction of a form displayed to collect information indicating a user preference for device data handling, according to an embodiment of the present invention;

FIG. 20e is a graphical screen depiction of a form displayed to collect information indicating a user preference for device data handling, according to an embodiment of the present invention;

FIG. 21a is a graphical screen depiction of a GeoFence alert report, according to an embodiment of the present invention;

FIG. 21b is a graphical screen depiction of a PDF version of the GeoFence alert report shown in FIG. 21a;

FIG. 21c is a graphical screen depiction of a speeding report, according to an embodiment of the present invention;

FIG. 21d is a graphical screen depiction of a PDF version of the speeding report shown in FIG. 21c;

FIG. 21e is a graphical screen depiction of an event log report generated in response to a request for device data in a custom report;

FIG. 22 is a diagram of a computer system that can be used to implement an embodiment of the present invention; and

FIG. 23 is a diagram of a conventional wireless network in an autonomous GPS environment.

### DESCRIPTION OF THE PREFERRED EMBODIMENT

A system, method, and software for timely and prioritized communication of information from a mobile telemetry device are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

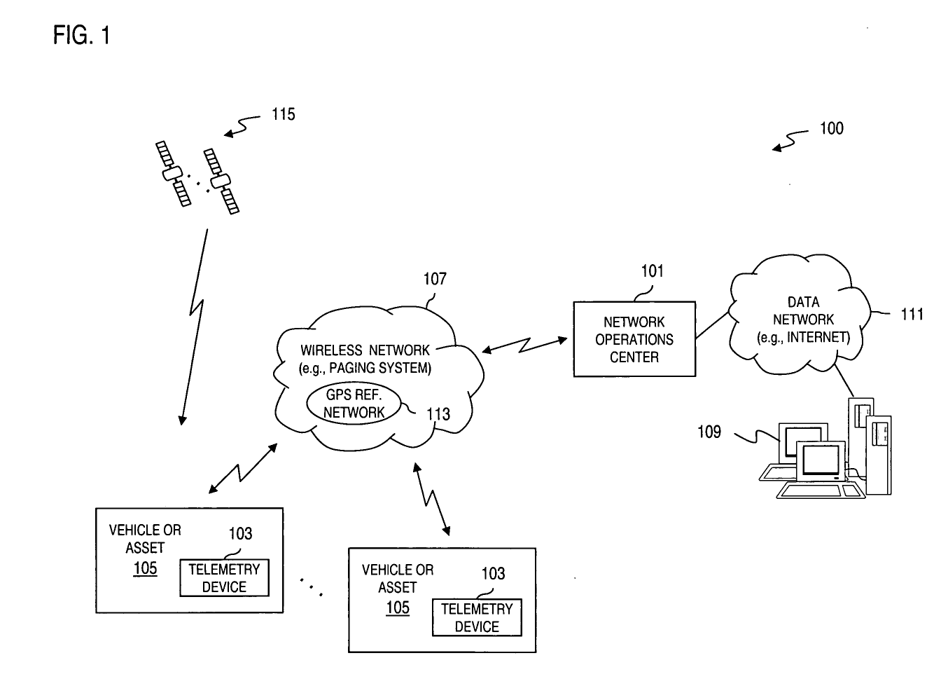

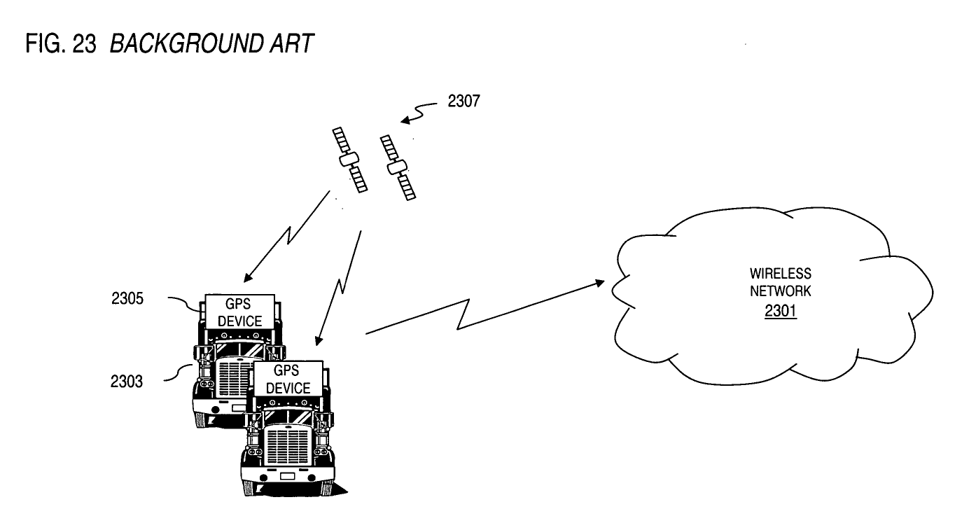

FIG. 1 shows a diagram of a fleet and asset tracking system, according to an embodiment of the present invention. The system 100, in contrast to the system of FIG. 23, utilizes a combination of autonomous GPS and Assisted GPS (A-GPS); in particular, mobile-centric A-GPS. The system 100 includes a Network Operation Center (NOC) 101 for tracking telemetry devices 103, which, under this scenario, are resident within vehicles 105. It is contemplated that the telemetry device 103 can be affixed to an asset (or any other object). A wireless network 107 supports two-way communication among the telemetry devices 103 and the NOC 101; the wireless network 107, in an exemplary embodiment, is a two-way paging system employing the ReFLEX™ protocol by Motorola for two-way advanced messaging. The telemetry devices 103 have two modes of operation: autonomous GPS mode, and A-GPS mode. When operating in A-GPS mode, the system 100 can provide for better in building or obstructed view geolocation with in a paging system zone. When out of network coverage, the autonomous GPS may be used to obtain geolocation data that may be stored on the device for later transmission.

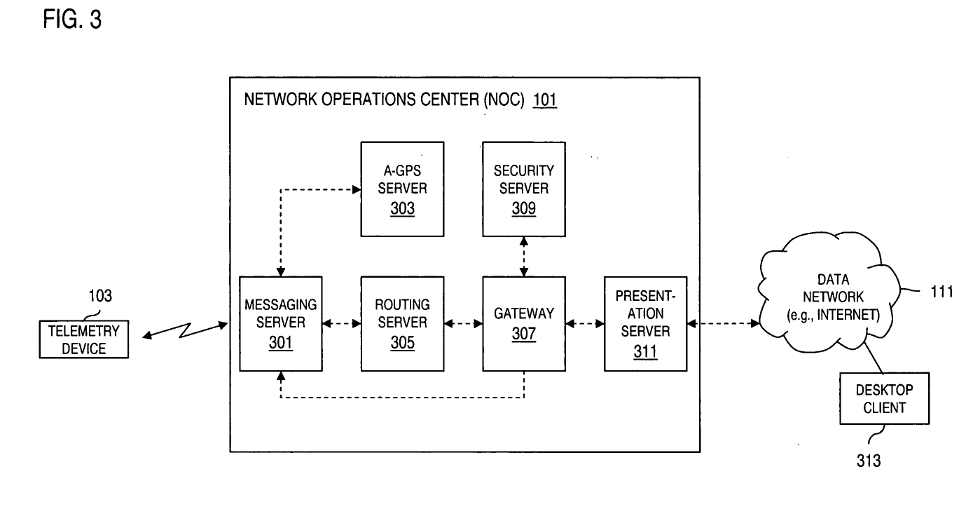

The NOC 101 provides the necessary fleet and asset management functions, such as user account creation and management, access control, and deployment of business rules; these functions are more fully described below with respect to FIG. 3. The NOC 101 also supports remote management capabilities by hosts 109 over a data network 111, such as the global Internet.

To better understand the hybrid A-GPS environment of the system 100, it is instructive to describe the operation of the general operation of a mobile-centric A-GPS system. The telemetry device 103 has GPS hardware and intelligence relative to the autonomous GPS scenario, whereby the network 107 in conjunction with the NOC 101 employs mechanisms for providing GPS aiding data (or assistance data). The network 107 includes base transmitters and some base receivers containing GPS hardware from which the ephemeris and approximate location can be obtained, constituting a GPS reference network 113.

The assistance data that is transmitted to the devices 103, in an exemplary embodiment, can include ephemeris data differential GPS correct data, timing data and/or other aiding data. Using the aiding (or assistance) data, the telemetry devices 103 performs geolocation calculations, yielding a number of advantages. For example, the telemetry devices 103 can generate real-time speed and route adherence alerts. Additionally, transmission of geolocation data need not be frequent. Transmission of geolocation data is more compact because it is true location rather than pseudo range data. Also, the telemetry devices 103 can more intelligently request assistance data because the devices 103 themselves can determine when the ephemeris data is no longer valid.

The hybrid A-GPS system 100 thus permits fast and precise geolocation when in network coverage of the network 101, while providing immunity from obstructed view of the sky. Also, when the switch is made to autonomous GPS mode (when outside of the coverage area of the network 101), the devices 103 can still obtain geolocation data. This data can be stored within the device 103 and transmitted to the NOC 101 when the associated vehicle 105 returns to the network coverage area.

As noted earlier, the telemetry devices 103 may be attached to a host entity such as a vehicle or other valuable asset. The device may be used to track, monitor, and control aspects of the host entity. These devices 103 are configurable with respect to the existence and number of digital inputs/outputs (I/O), analog inputs/outputs (I/O), and device port interfaces for connection with peripheral devices. By way of example, the digital inputs can be used to monitor various components of the vehicles 105: ignition status, door lock status, generic switch status, headlight status, and seat occupancy status. The digital outputs can be used to control, for example, the starter, and door locks, and to monitor such parameters as engine temperature, cargo temperature, oil pressure, fuel level, ambient temperature, and battery voltage. The exact configuration of the telemetry devices 103 can be based on cost consideration and/or applications.

The telemetry devices 103, in an exemplary embodiment, employ a wireless protocol to receive commands and transmit data and alerts (e.g., high speed alert) over the radio network 107. The telemetry devices 103 can queue alerts, message responses, and scheduled data, whereby if the devices 103 are unable to send the messages, the messages are queued and sent when the device 103 returns to wireless network coverage. Prioritized queues are used and include, for example, queues for high, normal, and low priority messages. In the exemplary implementation, critical device status changes are given highest priority, while other alerts and responses are given normal priority. Scheduled data messages are given the lowest priority. The queues are configured, as first in yields first out, wherein new messages are dropped when its corresponding queue is full. This arrangement advantageously allows for the status of the device 103 at the time of transmission failure to be known even when the data stored in the data log at time of the transmission has been overwritten.

The telemetry devices 103 can also respond to status (e.g., of position, speed, digital I/O port status, analog input channel status, peripheral status or other device status) queries transmitted by the NOC 101. The status query may request either current status or status within a time and date range. The device 103 responds to the query with either the current status or all status within the date and time range that is currently stored in the device's data log.

As regards data logging, the devices 103 support use of one or more schedules for the data acquisition. The data logging involves storing of the data locally on the device 103. This data, which can include position, speed, digital I/O port status, analog input channel status, peripheral status or other device status, is not automatically transmitted over the air. Instead, the data is stored for a finite period of time and made available for use by scheduled data acquisitions, data acquisitions on demand, and data acquisitions associated with alerts. The data log is circular in that when the last available memory for the data logger has been written, the data logger begins recording new data at the first location of memory available for the data logger.

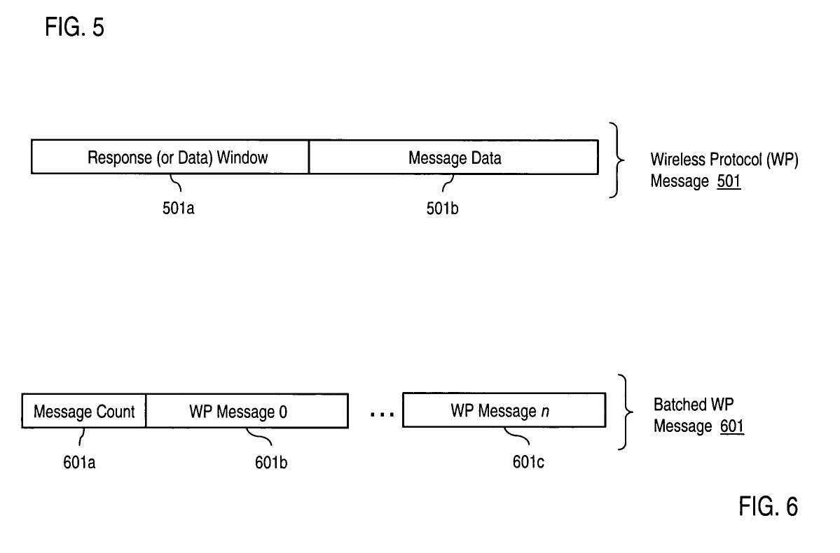

With scheduled acquisitions of the data collected by the data logger the data within the data log is transmitted by the device 103 according to a configurable schedule at the configured transmission rate. Multiple schedules may be configured on the device 103. Schedules are configured to obtain data at a regular interval based upon calendar time and date. Schedules may be configured such that they are enabled and disabled based upon status of a digital input. For example, an ignition status input may be used to turn a schedule on when the engine is on and turn the schedule off when the engine is off. A Response (or Data) Message Window value can be configured on the device 103, such that the device 103 delays sending scheduled data using an Offset within the Data Message Window (shown in FIG. 5). That is, the scheduled transmit time is adjusted by the Offset, the device 103 delays queuing the scheduled data until the time is equal to the transmit time plus the Offset. Use of the Data Message Window helps prevent overwhelming the wireless network when many devices are scheduled to transmit data at the same time. For example, it is likely that many schedules will be based upon transmitting on the hour, half past the hour, or at fifteen minute intervals. Using the Offset ensures that the scheduled data transmissions from all of the devices with similar schedules are not sent at precisely the same time. Given the precision of the telemetry device's clock (as it is based upon GPS time), this randomization of regularly scheduled device transmissions is particularly useful.

As mentioned previously, the telemetry devices 103 can be configured to monitor a variety of information relating to the vehicle or asset through the digital I/O and analog I/O. For instance, alerts can be used to indicate status change of the digital inputs. Each Digital Input Status Change Alert can be enabled and disabled through configuration. The alert may be configured to transmit other device status recorded at the time of the alert such as position, speed, status of other digital I/O ports, analog input status, peripheral status, or other device status. As regards the digital output, the status of each available digital output can be changed or read.

Similarly, the statuses of analog inputs of the devices 103 are monitored for change. In an exemplary embodiment, multiple threshold levels (e.g., high and low) can be set, whereby alerts are generated (e.g., Low Range Entry alert, Low Range Exit, High Range Entry, and High Range Exit). That is, if the value of the Analog Input falls below the Low Threshold, a Low Range Entry Alert is generated. If the value of the Analog Input rises above the Low Threshold, plus a Hysteresis value, a Low Range Exit Alert is generated. In similar fashion, if the value of the Analog Input rises above the High Threshold, a High Range Entry Alert is output from the device 103. Also, if the value of the Analog Input falls below the High Threshold minus a Hysteresis value, a High Range Exit Alert is generated. The alert may be configured to transmit other device status recorded at the time of the alert such as position, speed, status of other digital I/O ports, analog input status, peripheral status, or other device status.

By way of example, the devices 103 can be used to monitor excessive speed via a High Speed Alert Control, whereby a High Speed Threshold can be set by a fleet manager. In addition, a duration parameter (i.e., High Speed Duration) can be utilized to specify the time at which the High Speed Threshold must be exceeded before an alert is generated. Further, a configurable High Speed Hysteresis parameter is set as the delta change below the High Speed Threshold used to determine when the High Speed Threshold has no longer been exceeded. The alert may be configured to transmit other device status recorded at the time of the alert such as position, speed, status of other digital I/O ports, analog input status, peripheral status, or other device status.

The system 100 also permits users via the hosts 109 to specify and configure areas of interest within the coverage area of the network 101 such that alerts can be generated when a device 103 enters or exits the configured areas. The alert may be configured to transmit other device status recorded at the time of the alert such as position, speed, status of other digital I/O ports, analog input status, peripheral status, or other device status.

The data collected and transmitted by the telemetry devices 103 are processed by the NOC 101, the components of which are described in FIG. 3.

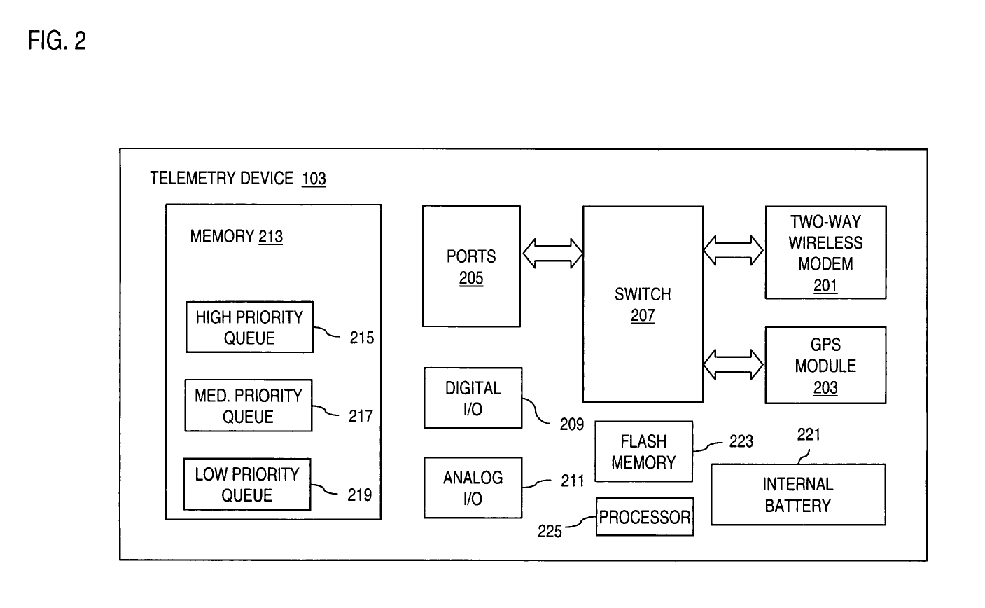

FIG. 2 shows a diagram of a telemetry device used in the system of FIG. 1, according to an embodiment of the present invention. The telemetry device 103, which can be deployed within a vehicle (as shown in FIG. 1 or coupled to any asset), operates within the wireless network 107. By way of example, the components of the telemetry device 103 are described in the context of a narrowband network, such as a paging system; however, it is contemplated that the components for communications can be tailored to the specific wireless network.

In this exemplary embodiment, the telemetry device 103 includes a two-way wireless modem 201 for receiving and transmitting signals over the wireless network 107 according to the communication protocols supported by the wireless network 107, such as the Motorola ReFLEX™ protocol for two-way paging. By way of example, a Karli ReFLEX™ module by Advantra International can be used for the modem 201. The two-way wireless modem 201 couples to a two-way wireless antenna (not shown) that can be placed local to the device 103 or remote from the device 103 (e.g., 12 or more feet) to enhance flexibility in installation.

The telemetry device 103 also contains a GPS module 203 that is capable of operating in the multiple GPS modes: autonomous GPS mode, and mobile-based A-GPS mode. The GPS module 203 can employ, for example, a GPS receiver manufactured by FastraX-iTrax02/4. In autonomous mode, GPS data may be acquired with no assistance data provided by the wireless network 107. The GPS module 203 operates in the A-GPS mode when the device 103 is in wireless network coverage, in which assistance data is supplied and can include ephemeris data and data to obtain location in obstructed view locations (in building, wooded areas, etc.). Further, the assistance can include differential GPS (DGPS) to enhance location accuracy under some conditions. The GPS module 203 couples to a GPS antenna (not shown) that can be placed local to the device 103 or remote from the device 103 (e.g., 12 or more feet) to enhance flexibility in installation.

Attachment of peripheral modules to the telemetry device 103 is supported by one or more peripheral ports 205. The ports 205, for example, can be used to connect to intelligent peripherals that operate according to business rules and logic. These business rules and logic can be housed in a vehicle harness (not shown), which include an On-Board Diagnostic (OBDII) interface and intelligence. Under this arrangement, a user (e.g., fleet manager) can query any parameter available through the OBDII interface. For example, data obtained for each tracking record can include any combination of the following items: RPM (Revolutions Per Minute), oil pressure, coolant temperature, etc. Such data recorded by the telemetry device 103 is stored in memory 213. The acquisition period for the data is configurable, as well as the transmission interval to the NOC 101. Furthermore, the monitoring and subsequent data exchange can be governed by a configurable schedule, which can specify such parameters as start date, start time, end time, recurrence (e.g., daily, weekly, monthly, etc.), and duration.

Data is logged by a data logger 207, made available for use by scheduled data acquisitions, data acquisitions on demand, and data acquisitions associated with alerts. As mentioned, the telemetry device 103 also can be configured to include digital I/O 209 and analog I/O 211 for monitoring and control of the vehicle or asset. The data logger 207 also collects data associated with these I/O ports 209, 211.

The telemetry device 103 also includes a processor 225 that may handle arithmetic computations, and may support operating system and application processing. The processor 225, while shown as a single block, may be configured as multiple processors, any of which may support multipurpose processing, or which may support a single function.

The memory 213 of the telemetry device 103 can be organized to include multiple queues for prioritizing the messages to be processed by the device 103. In an exemplary embodiment, the memory 213 includes a High Priority queue 215, a Medium Priority queue 217, and Low Priority queue 219. The memory 213, while shown as a single block, may be configured as multiple memory devices, any of which may support static or dynamic storage, and may include code for operating system functionality, microcode, or application code.

Data recorded by the telemetry device 103 may additionally be stored in a storage medium other than the prioritized queues 215, 217, and 219, such as in a flash memory 223. A log (not shown) of information may be kept so that the information may be transmitted according to a schedule, as discussed above, or, e.g., upon receipt of a request to send all data that has been collected. Storage devices have only a finite amount of space for storage of information, and thus the information for only a finite number of messages may be stored in either the prioritized queues 215, 217, 219 or the flash memory 223.

In an exemplary embodiment, information collected, e.g., for up to a 72-hour period may be stored in a log in the flash memory 223. The information may be stored in the log as elements in a queue, in which the information elements are processed according to a first-in-first-out scheme.

To improve availability of the telemetry device 103, an internal battery 221 is optionally included. With the internal battery, the telemetry device 103 can continue to monitor and transmit alerts and status information to the NOC 101 even if the electrical system of a vehicle is inoperable. Additionally, the internal battery 221 can be used by the device 103 to gracefully report power status wirelessly and shut down gracefully when the energy level of the internal battery is becoming too low to sustain operation of the device.

The functions of the NOC 101, which interacts with the telemetry devices 103 to exchange information for supporting fleet and asset management, are detailed with respect to FIG. 3.

FIG. 3 shows a diagram of a Network Operations Center (NOC) in the system of FIG. 1, according to an embodiment of the present invention. The NOC 101 utilizes, in this exemplary embodiment, a client-server architecture to support the telemetry devices 103. Specifically, the NOC 101 houses a messaging server 301 for sending and receiving messages to the devices 103 over the air, for storing the messages, and routing these messages to their destination. The NOC 101 provides connectivity via a local area network (LAN) (not shown) for the messaging server 103 with an A-GPS server 303, a routing server 305, and a gateway 307. The gateway 307 communicates a with a security server 309 to support encryption and decryption of the messages. A presentation server 311 resides within the NOC 101 to interface with the data network 111 (e.g., the global Internet), such that the host 109 can access the services of the fleet and asset management system. The host 109 under this scenario is loaded with a desktop client 313.

Although a single server is shown for the presentation server 311, in the alternative, the server 311 can functionally be implemented as three separate servers: a database server, a middleware server, and a web server. The database server is responsible for data storing, data updating, and data retrieval as well as providing a set of interfaces to achieve these functions. The web server is responsible for serving maps, presenting user interfaces to manage and control user administration, device configuration, and etc. The middleware server can be deployed between the database server and the web server, and has the following responsibilities: 1) converting the web server's data retrieval requests to database server APIs and then sending to database server, 2) receiving the responses from the database server and then sending back to web server, 3) receiving data from gateway 307 and then sending requests to the database to store/update data records. Because of the modularity in this design, these three components can reside on the same machine, as shown in FIG. 3, or reside in multiple platforms.

Messages from the telemetry devices 103 are forwarded by the messaging server 301 to either the A-GPS server 303 or the routing server 305. If the message is an assist request, this message is sent to the A-GPS server 303. In response to the GPS assist request, the A-GPS server 303 determines GPS assistance data for transmission to the requesting telemetry device 103.

The A-GPS server 303 obtains ephemeris data from the GPS reference network 113, and determines satellite configuration for each of the geographic zones comprising the wireless network. The A-GPS server 303 also determines the assistance data for each geographic zone. The NOC 101 then periodically broadcasts the assistance data to each geographic zone. In addition, the A-GPS server 303 supplies GPS assistance data to any telemetry device 103 that requests the GPS assistance data. When supporting this request, the NOC 101 determines approximate location of the requesting device 103 (based upon base receivers that received the request, using a type of triangulation. Subsequently, a GPS Assistance message is generated by the A-GPS server 303 to send to the telemetry device 303 based upon its approximate location. The messaging server 301 sends the GPS Assistance message to the particular telemetry device 103.

Thus, the A-GPS server 303 delivers GPS assistance data through two mechanisms by periodically broadcasting GPS assistance data to all devices 103 in each of the geographic zones covered by the wireless network 107, or by responding to specific requests by the telemetry devices 103 for GPS assistance data.

The routing server 305 has responsibility for routing of the messages from the telemetry devices 103, and managing such messages from the devices 103 to their server destinations. Each device 103 can be configured to have messages directed to one or more destination servers. The routing server 305, upon receiving message from a telemetry device 103, determines a destination address that has been configured for the device 103 and modifies the destination address accordingly. The message is then forwarded to the configured destination. By default, the messages are directed to the gateway 307.

The gateway 307 interfaces with the presentation server 311 to permit the desktop client 313 access to the fleet and asset management system. The gateway 307 provides translation of wireline messages and commands from the presentation server 311 to the wireless protocol for communication with the telemetry devices 103. For example, the gateway 307 supports an extensible Markup Language (XML) interface, such that XML commands submitted to the gateway 307 over wireline are converted to the wireless protocol commands and sent over the paging network 107 to the devices 103. In turn, the wireless protocol messages received from the devices 103 are converted to wireline XML messages. The gateway 307 provides translation of wireline messages and commands from the host 109 to the wireless protocol for communication with the telemetry devices 103. In turn, the wireless protocol messages received from the devices 103 are converted to wireline XML messages and sent to host 109.

The presentation server 311 provides the following functions: fleet and asset tracking, and general purpose I/O monitoring and control. The server 311 also maintains a database (not shown) for user accounts and other related data (e.g., configuration data, user management information, device management, and data acquired from the devices 103). The presentation server 311, as mentioned, also generates the maps corresponding to where the devices 103 are tracked and the mapping preferences configured. Using the desktop client 313, a user can even issue requests to command a particular device 103, such as requesting location of the device 103.

With the presentation server 311 as a front end, a user via the desktop client 313 can configure the telemetry devices 103 via web interfaces. In an exemplary embodiment, the server 311 is a World Wide Web (“web”) application server to support a web browser based front-end for the desktop clients 109. The web application server (not shown) can be deployed to support such web interfaces as a set of Java Server Pages (JSP) and Java Applet to interact with the user on the desktop client 313. On the backend, based on data collected by JSP and Java Applet, the web server can generate the proper XML commands that are compliant with Application Programming Interface (API) of the presentation server 311. Consequently, the collected records can be stored in the database of the presentation server 311. The database also stores the properties of the telemetry devices 103, such as the alerts and thresholds earlier described.

The desktop client 313 interfaces to the system 100 through the presentation server 311. From the desktop client 313, the user logs in to the system 100. The presentation server 311 can also perform authentication as well as administration tasks such as adding new users or devices 103. The user can also configure business rules executed by the presentation server 311, wherein the business rules logic uses this user supplied configuration to configure the devices 103, acquire, and process data from the devices 103.

Additionally, the presentation server 311 provides a reporting capability based on the stored information in the database. The presentation server 311 can support standard reports or customize reports to the user via the desktop client 313.

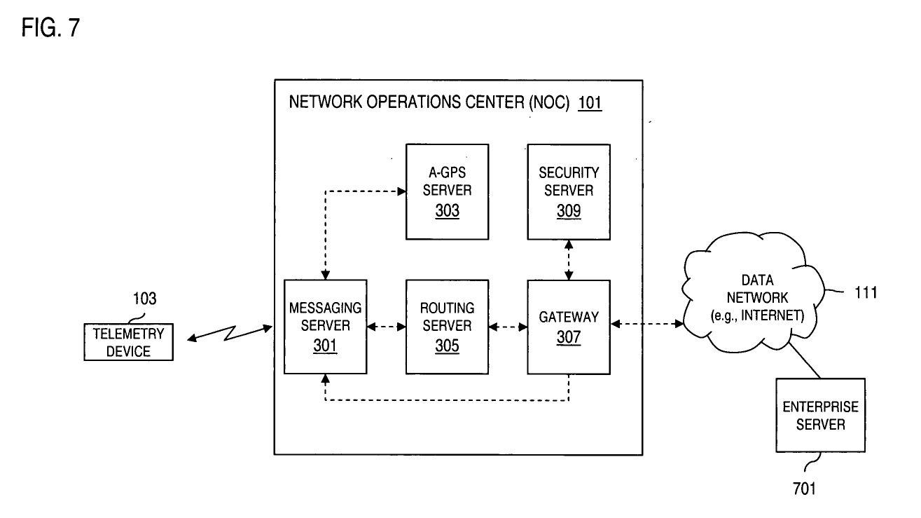

Instead of using a desktop client 313, the user, if associated with a large organization, can utilize an enterprise server to obtain all of the user functionality through the gateway 307 using the API of the fleet and asset management system 100. Accordingly, the enterprise server would possess the functional capabilities of the presentation server 311, but would be managed by the customer (or user) at the customer's premise, as shown in FIG. 7.

As noted, the wireless protocol supports communications between the NOC 101 and the telemetry devices 103. In an exemplary embodiment, the messaging is performed according the FLEXsuite Uniform Addressing & Routing (UAR) protocol (developed by Motorola). The wireless protocol message, which can be encapsulated with an UAR message, is unencrypted.

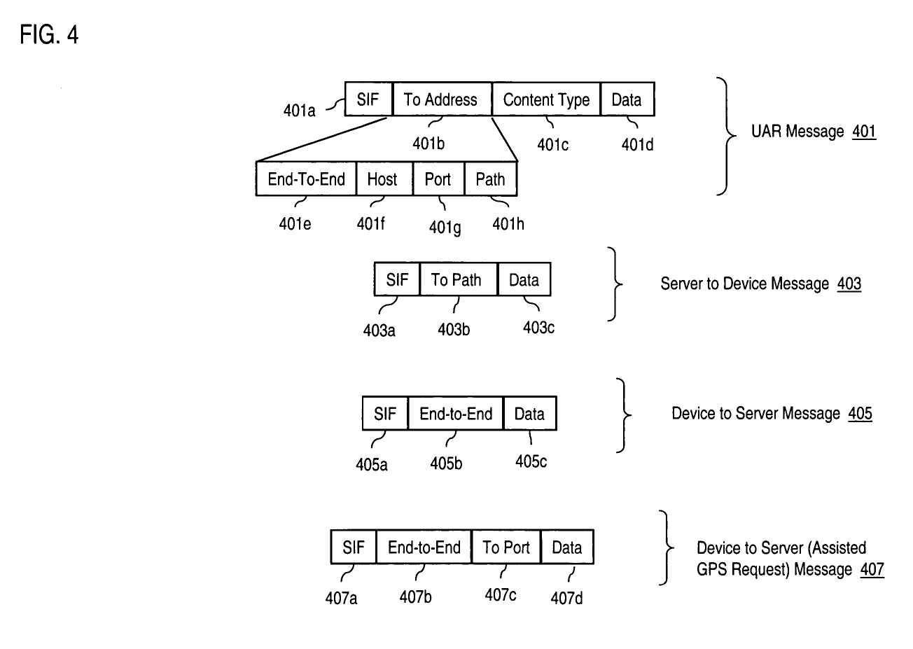

FIG. 4 shows a diagram of the formats of protocol messages used in the system of FIG. 1. By way of example, the protocol is the UAR protocol. Accordingly, a UAR message 401 includes the following fields: a Status Information Field (SIF) field 401a, a Destination Address (“To Address”) field 401b, a Content Type field 401c, and a Data field 401d. Table 1, below, defines these fields 401a-401c.

TABLE 1

| Field | Definition | Data Type | Size |
|---|---|---|---|
| SIF | Identifies the application protocol | Integer | 8 bits |
| | used to encode the remaining data in | | |
| | the message; indicates UAR | | |
| | addressing is used | | |
| To | Destination Address | UAR “To | Variable |
| Address | | Address” | |
| | | Encoding | |
| Content | Identifies the format of the attached | UAR | 24 bits |
| Type | Data | Content | |
| | | Type | |
| Data | UAR format data payload | UAR data | Variable |

With respect to the “To Address” field 401b, this address can be further specified the following fields: an End-To-End field 401e, a Host field 401f, a Port field 401g, and a Path field 401h. The End-To-End field 401e is utilized for device to server routing. It is noted that no addressing is needed for device to server routing with the exception of an Assisted GPS Request message. Because the routing server 305 controls message routing from the telemetry device 103, some of the address information requirement is specific to UAR. Path Addressing, per the Path field 401h, is used for server to device routing, as in the case, for example, addressing of a peripheral device attached to the telemetry device 103. As shown in FIG. 4, for server to device messaging, message 403 can be used and includes a SIF field 403a, a To Address field 403b specifying the path, and a Data field 403c. A device to server message 405 utilizes a SIF field 405a, a To Address field 405b specifying the End-to-End address, and a Data field 405c. In the case of a device to server transmission relating to acquisition of Assisted GPS (e.g., in form of an Assisted GPS request), a message 407 is provided, and includes a SIF field 407a, a To Address field specifying the End-to-End address 407b and Port 407c, and a Data field 405c.

As regards UAR messages in general, the Data field 401d contains binary formatted data, which is the unencrypted Wireless Protocol (WP) message (as described in FIGS. 5 and 6).

FIG. 5 shows a diagram of the format of a Wireless Protocol (WP) message used in the system of FIG. 1. A Wireless Protocol message 501 includes a Response Window (or Data Window) field 501a to regulate the over-to-air transmission of the message from the telemetry device 103 to the NOC 101, as described previously. In other words, with the telemetry devices 103, accommodation is made to support staggering of device responses to prevent overwhelming the reverse path of the wireless network 107 (FIG. 1) if a command is sent to a large number of devices in a broadcast message. The Response Window field 501a is thus used to specify a desired time frame for obtaining responses from deployed devices 103. If a Response Window is specified in a message, the device 103 delays sending its response using an Offset value within the Response Window when responding to the message. That is, after first processing the message, the device 103 delays sending the response to the message until the Offset time has expired. To ensure a good distribution of responses during the Response Window, the device 103, in an exemplary embodiment, can randomly select an Offset time within the specified time window.

The message 501 also provides a Message Data field 501b for specifying the data (such as data within the data log, and alerts).

According to one embodiment of the present invention, the NOC 101 can batch the WP messages 501 to reduce overhead, resulting in a batched message 601. The batched message 601 specifies a Message Count field 601a to indicate the number of WP messages 501 (0 . . . n, where n is an integer) that are contained within the batched message 601. The WP Message fields 601b, 601c pertain to the corresponding messages specified by the Message Count value in the field 601a. The messages of FIGS. 5 and 6 support a number of transactions between the NOC 101 and the telemetry device 103. For example, server transactions involve a request being sent from a server (e.g., servers 301, 303, and 305) to the device 103 and a response sent from the device 103 to the server. For instance, in a Device Configuration Request from the NOC 101 to the device 103, the information enumerated in Table 6 is transmitted.

FIG. 7 shows a diagram of a Network Operations Center (NOC) in the system of FIG. 1, according to an embodiment of the present invention. An enterprise approach eliminates the need for the presentation server 311 in the NOC 101. An enterprise server 701 communicates directly with the gateway 307 over the data network 111. This architecture advantageously provides the customer with greater flexibility in developing applications for the fleet and asset management system 100.

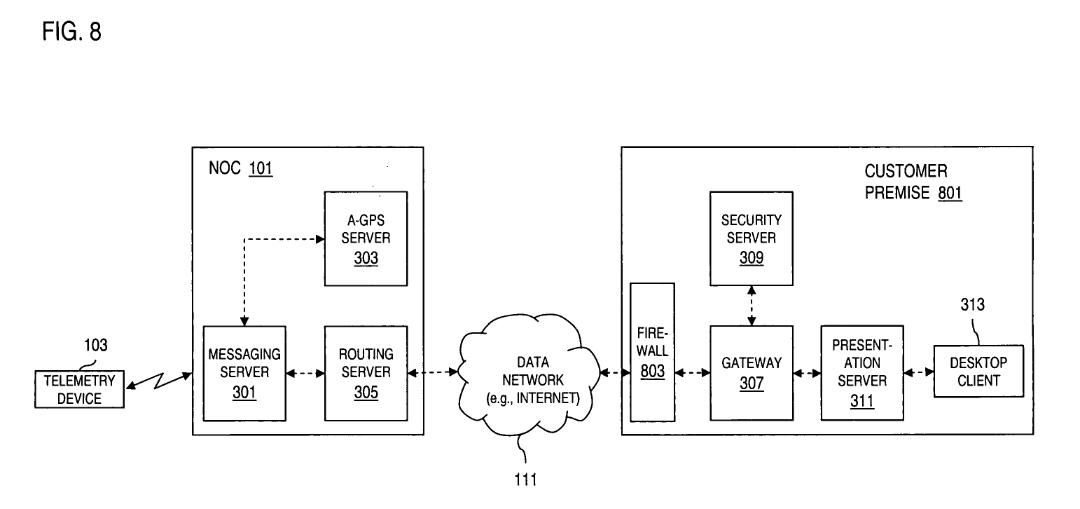

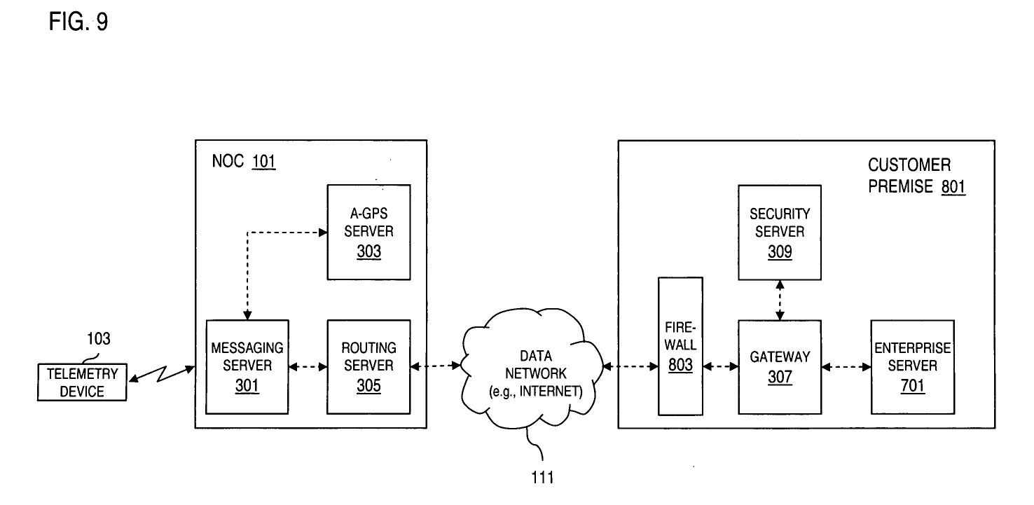

The discussion thus far of the fleet and asset management system 100 has provided security from the telemetry devices 103 to the NOC 101 through use of the security server 309 resident within the NOC 101. In the alternative, end-to-end encryption can be supported by situating the security server at the customer premise, as described in FIG. 8 and FIG. 9.

FIG. 8 shows a diagram of a fleet and asset management system with end-to-end encryption, according to an embodiment of the present invention. Under this architecture, a customer premise 801 houses the security server 309, the gateway 307, and the presentation server 311. The presentation server 311 operates with the desktop client 313 as detailed with respect to FIG. 3. In this example, a firewall 803 is implemented between the data network 111 and the gateway 307; this added security feature eliminates any potential gaps in security at the NOC that occurs when decrypting the wireline message and re-encrypting the wireless message.

FIG. 9 shows a diagram of a fleet and asset management system with end-to-end encryption in an enterprise environment, according to an embodiment of the present invention. In this scenario, the customer premise 801 does not house the presentation server 311 that communicates with the desktop client 313, but instead includes the enterprise server 701.

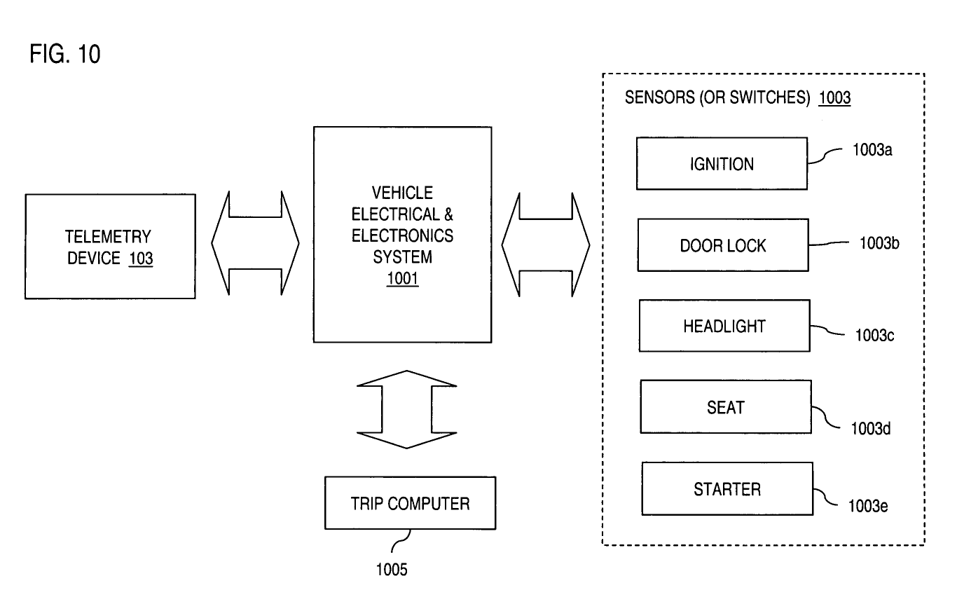

FIG. 10 is a diagram of the telemetry device of FIG. 2a deployed within the vehicle, according to an embodiment of the present invention. In this exemplary scenario, the telemetry device 103 interfaces with a vehicle electrical and electronics system 1001 to obtain data relating to a variety of environmental and diagnostic information. For instance, the vehicle electrical and electronics system 1001 can include electrical sensors (or switches) 1003 deployed through the vehicle. These sensors 1003 can relay information regarding status of the following: ignition 1003a, door lock 1003b, headlight 1003c, seat occupancy 1003d, and starter 1003e. Also, the system 1001 can include a trip computer 1005 that records information regarding, for example, speed, average speed, distance traveled, fuel level, fuel economy, distance to empty fuel tank, RPM, coolant temperature and level, oil pressure, alternator and brakes, battery voltage, windshield washer fluid level, ambient temperature, cargo temperature, and outside temperature. The data relating to the system 1001 is collected by the telemetry device 103 within its prioritized queues and data log and made available to the NOC 101.

This process of data collection and subsequent transmission to the NOC 101 can be triggered according a configurable schedule. Moreover, the schedule can be activated or deactivated based upon status of an input/output 209, 211, such as ignition On/Off state.

Although the above discussion involves the telemetry device 103 collecting data in an automotive context, it is recognized that data relating to any asset can be gathered.

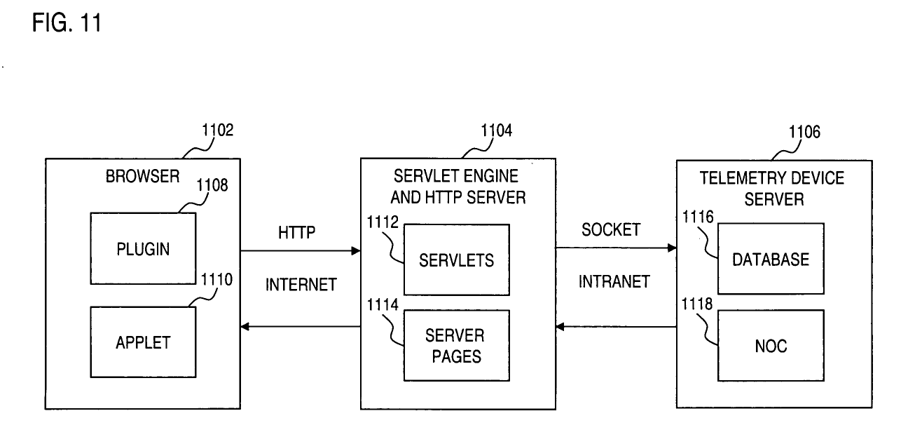

FIG. 11 is a diagram of an exemplary arrangement of system components for configuring a web browser for fleet or asset tracking and management according to an embodiment of the present invention. A browser 1102 includes a plugin 1108 and an applet 1110 for communication with a servlet engine and HTTP server 1104 via HTTP communication. The browser 1102 may be included, e.g., on the desktop client 313. The servlet engine and HTTP server 1104, which may be included on the presentation server 311, communicate with a telemetry device server 1106 via sockets on an intranet. Servlets 1112 and server pages (e.g., JSP) included in the servlet engine and HTTP server 1104 process maps and requests from a user interacting with the browser 1102. A database 1116 of the telemetry device server 1106 is used, e.g., for storing data received from the telemetry devices 103 and the NOC 1118 of the telemetry device server 1106 interfaces with the telemetry devices 103 to send and receive messages including data from the devices 103 in response to requests sent to the devices 103.

User interfaces may be implemented in many other forms other than the web browser 1102 using the plugin 1108 and the applet 1110, and thus the scope of the invention is not limited to this example.

Exemplary components may include a number of servlets and their names (e.g., as shown below) may be descriptive of functionality. Another exemplary component may include an applet component (e.g., fleethawk.jar) that includes a set of Java classes and small image icons:

/deviceproperties.do
/demanddata.do
/editaccount.do
/edituser.do
/managefleet.do
/speedingreport.do
/reportfilter.do
/geofencealertreport.do
/savedreports.do
/reportfilter.do
/managetemplates.do
/servlet/getmapimage
/servlet/geocoderelay
/servlet/appletbeanhandle
/servlet/raptor.servlet.GetVehicleIcon
applet (fleethawk.jar)

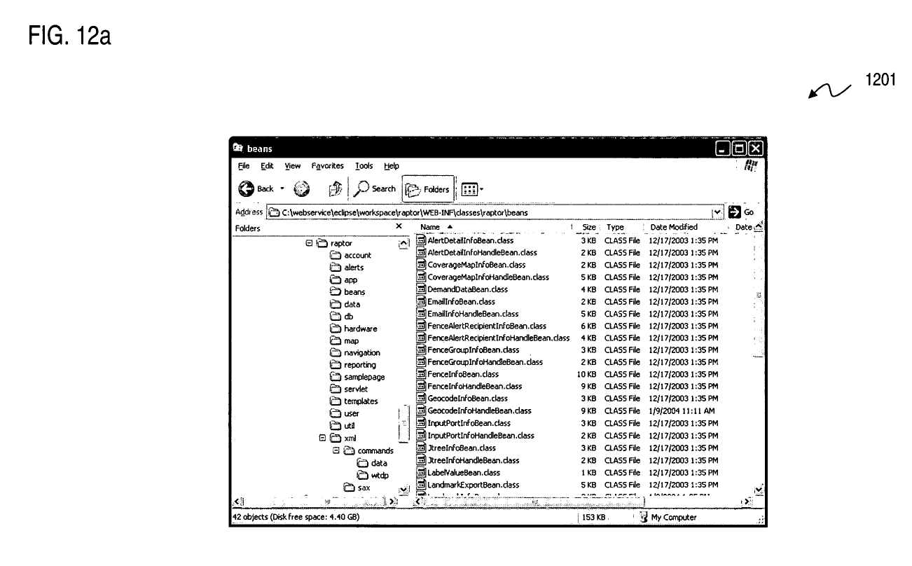

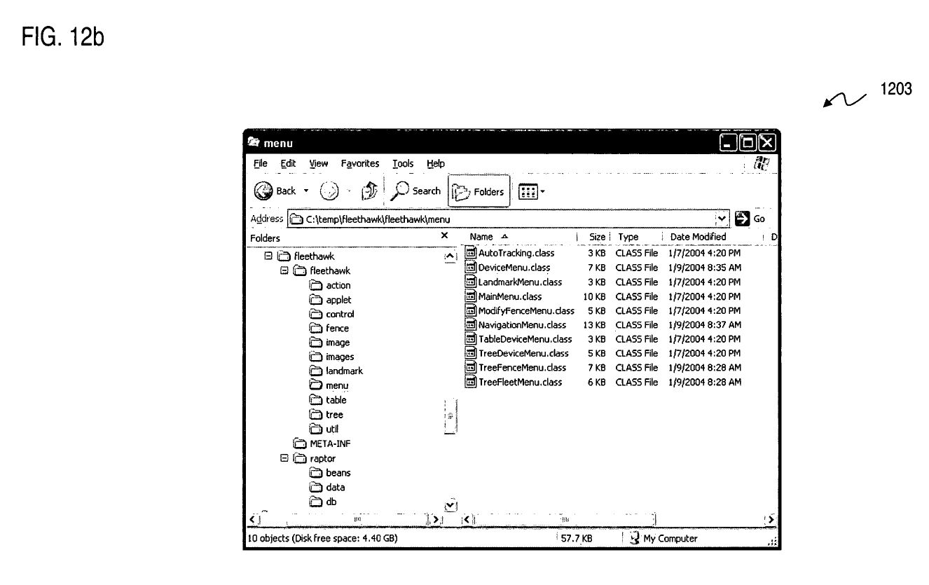

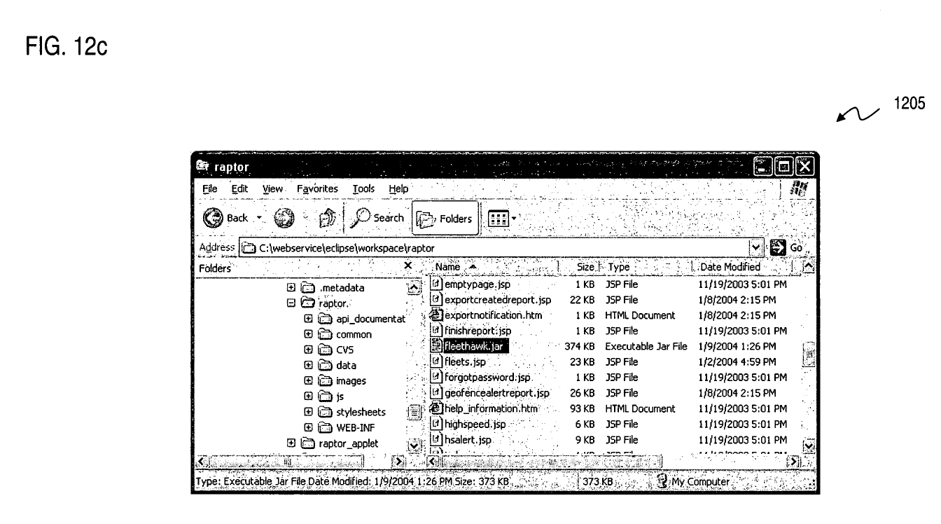

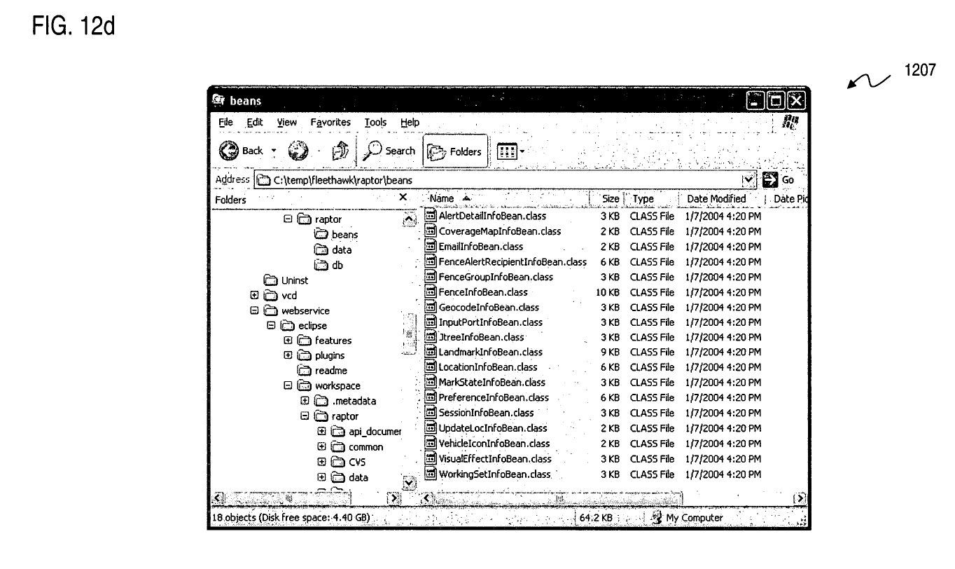

On an exemplary UI system server side, there are more than 300 custom built Java classes to handle the business logic at the server side, together with other JSP pages, JavaScript files, image files, style sheet files, and template files to serve the dynamic and static content of an exemplary telemetry system project. Exemplary custom-built-server-side web components may total more than 450. In addition, the exemplary applet (e.g., fleethawk.jar) may include approximately 200 components including Java classes and small image icons. FIG. 12a is a graphical screen depiction 1201 of a listing of classes of an exemplary Java class hierarchy for such an exemplary user interface system server, according to an embodiment of the present invention.

FIG. 12b is a graphical screen depiction 1203 of a listing of classes of an exemplary applet class hierarchy for an exemplary user interface system, showing an exemplary applet side Java class hierarchy. Exemplary functions handled by an exemplary telemetry system applet 1110 include but are not limited to: sending instructions to the servlet 1112 for generating new maps; drawing a GeoFence on a map; displaying a fleet/vehicle hierarchy on the browser 1102; displaying GeoFence/vehicle relationship on the browser 1102; manipulating a map such as zooming in, zooming out, and panning; changing a GeoFence color and name; modifying a vehicle shape and color; sorting a location/landmark table shown underneath the map; and creating/loading/modifying landmarks.

An exemplary implementation identifies and locates all needed Java libraries, resource files (such as mapping packages and XML parsers) on the applet side. In this scenario, as an example, more than 6 MB of files may be downloaded from the web server to the client so that the applet may function correctly. For users having a high speed Internet connection, this may be acceptable but still may require undesirable wait time for downloading. In lieu of the download, the applet is rewritten to keep the transfer as lightweight as possible. For example, many of the map processing loads are shifted to the server side such that all files for the applet are wrapped into ajar file whose size is only approximately 374 KB. Map information may be sent in an image file together with associating data (e.g., vehicles on map, landmarks on map, GeoFence on map, longitude, latitude, size). Thus, download resources are significantly spared. As an example, FIG. 12c is a graphical screen depiction 1205 of an exemplary jar file for the applets shown in FIG. 12b.

FIG. 12d is a graphical screen depiction 1207 of a listing of classes of an exemplary JavaBean classes for an exemplary user interface system server, for information exchange between the applet 1110 and the server 1104. Some exemplary telemetry system clients may be corporate users, who may, e.g., reside behind a corporate firewall. To maintain the applet-server-communication, standard HTTP protocol may be utilized. However, as many different types of requests are to be sent from the applet 1110 to the server 1104, plain HTTP protocol may not suffice. Therefore, a servlet is created to transport JavaBean objects based upon standard HTTP protocol (e.g., via a feature of Java). In an exemplary configuration, as shown in FIG. 12d, approximately 20 JavaBean objects are transported by the servlet 1112.

This exemplary servlet is “smart enough” to find a corresponding Java class to handle a JavaBean object by examining the object name using the Reflection mechanism provided by Java and Java Object Input/Output Stream. As long as predetermined exemplary programming conventions are followed, any number of JavaBean class may be created and may be handled by the servlet 1112 without any modification of the servlet 1112 itself, thus minimizing at least developer/programmer resources and storage resources.

An exemplary user interface for use with the telemetry devices described previously includes a graphical user interface, as discussed below.

Although not shown, it is to be understood that an exemplary configuration may enable a user to control a vehicle or asset associated with the telemetry device 103, e.g., turning a vehicle ignition on, turning the vehicle ignition off, locking a door, unlocking the door, turning on a temperature control system, turning off the temperature control system, turning on a refrigerating control system, and turning off the refrigerating control system.

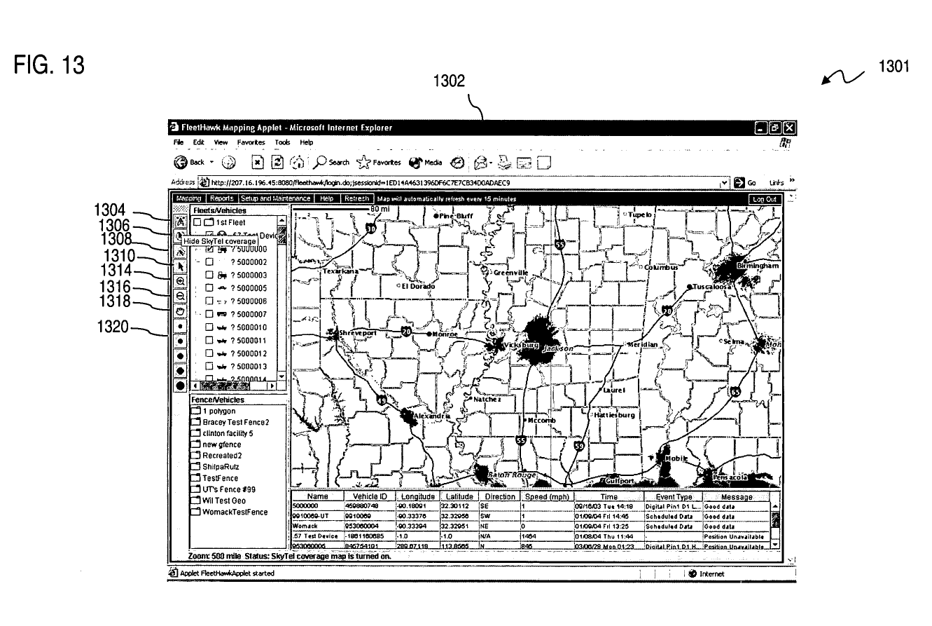

FIG. 13 is a graphical screen depiction 1301 of a map of a provider coverage area, according to an embodiment of the present invention. It is understood that the interface shown and described may take on many variations with departing from the scope and spirit of the present invention. As shown in FIG. 13, control Buttons in the exemplary configuration are on the left side of the user's screen 1302. Control buttons allow a user to view provider coverage on a map, change the view, move the map, and set up GeoFences. As a user clicks the control buttons, the user's mouse may look slightly different on the map when the user uses Zoom, Pan, or GeoFence buttons.

As shown, a coverage button 1304 resembles a transmission tower. This button enables a user to see the provider's coverage areas on a currently displayed map. Clicking the button displays the provider's coverage, and clicking it again removes the coverage display. In this example, fleet vehicles must be in the provider's coverage to communicate data points to the website (e.g., a Fleethawk web site). Underlying geographic map software utilized in conjunction with the interface system for use in geographic map display may, e.g., include MapXtreme Java Edition, StreetPro, and MapMarker, available from MapInfo (e.g., at http://www.mapinfo.com).

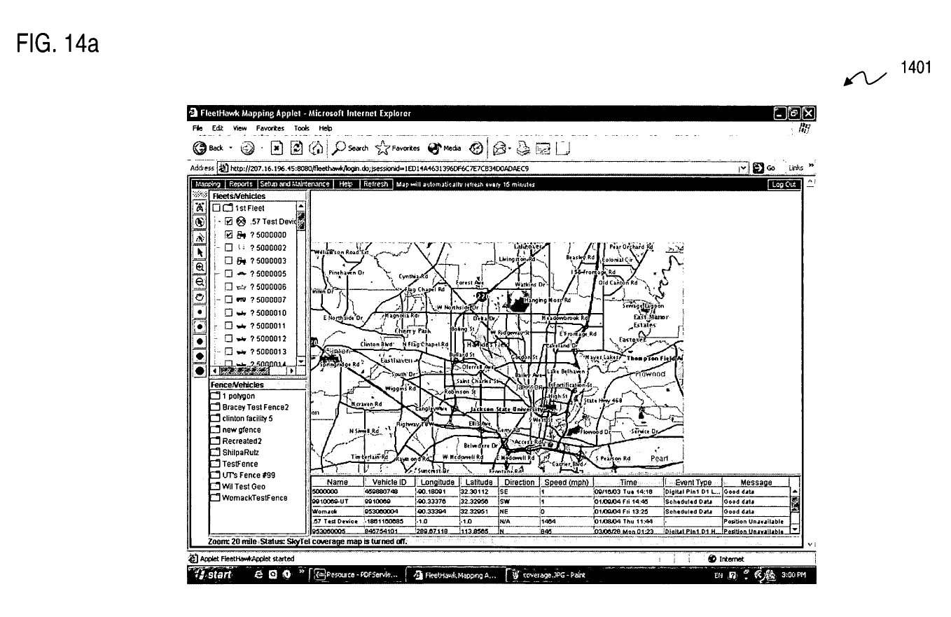

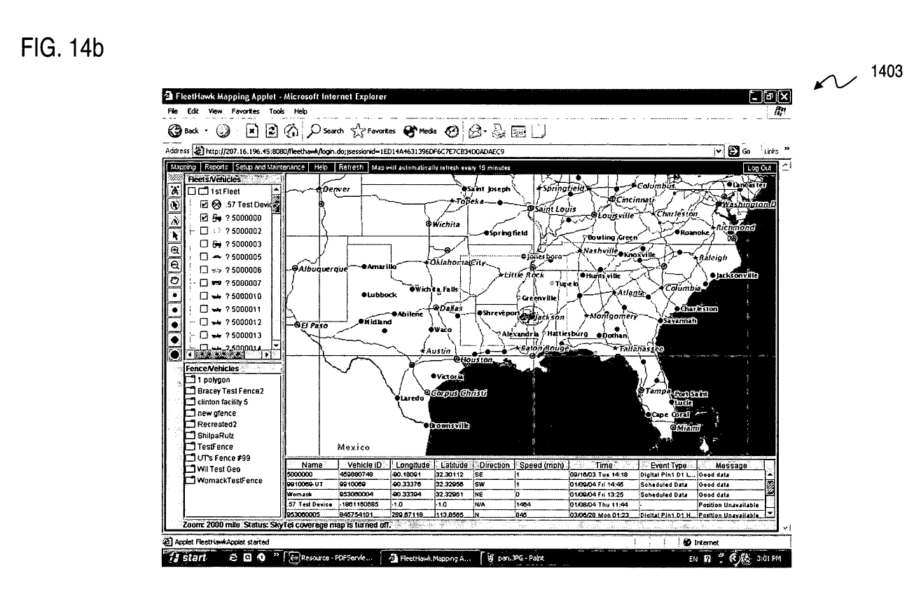

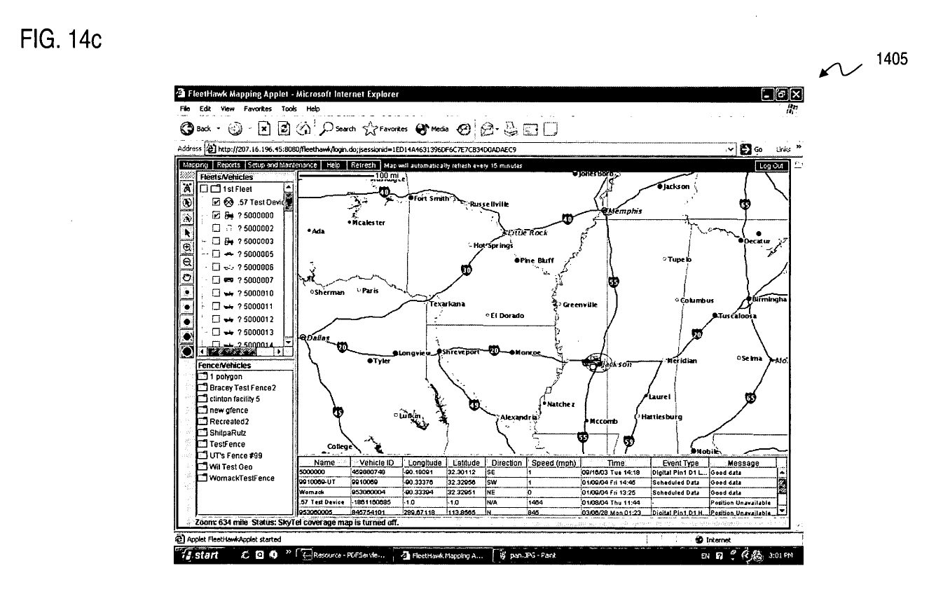

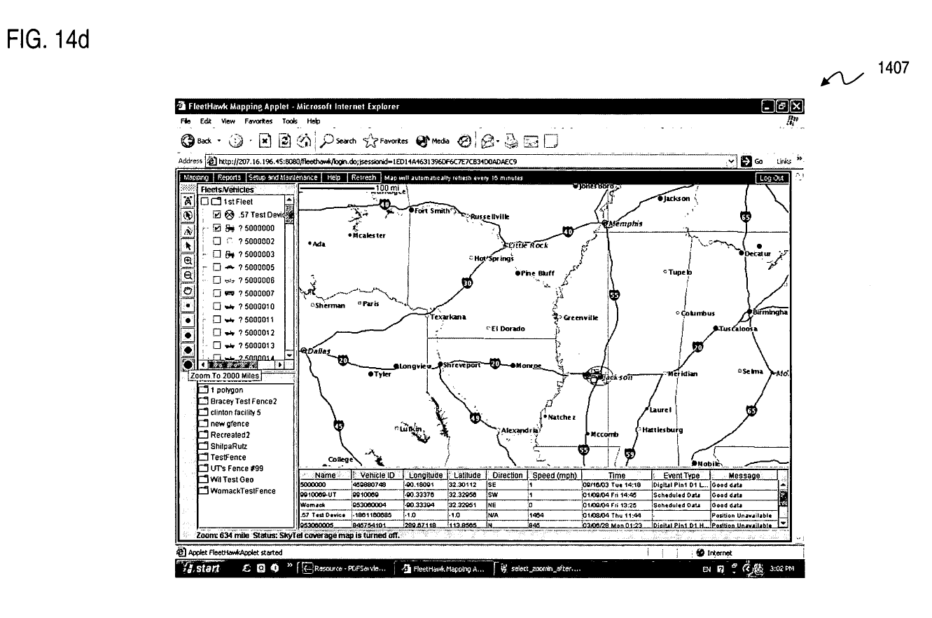

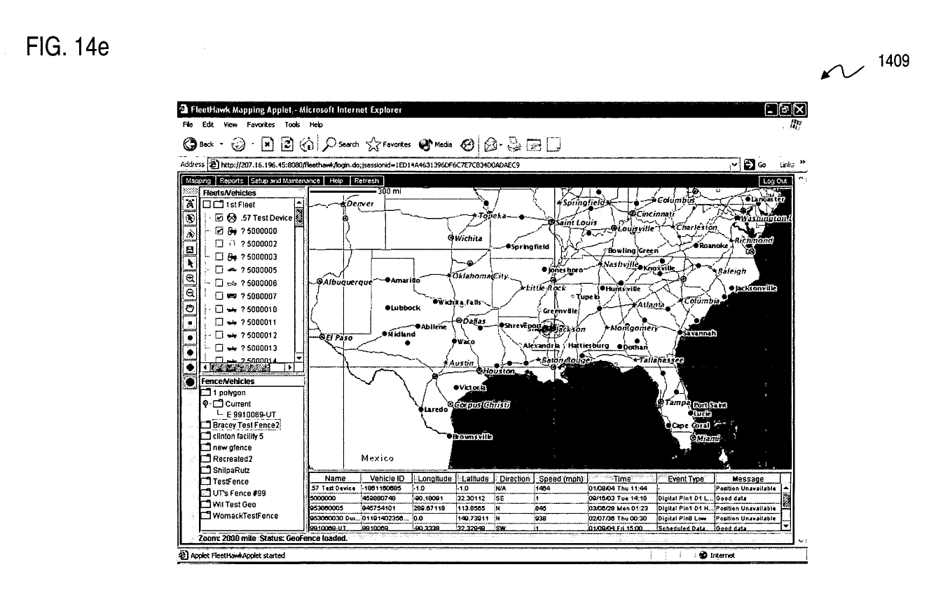

A pan button 1316 includes a small hand. Clicking on this button enables the user to ‘grab’ the displayed map and move it in any direction, allowing the user to view the areas immediately adjoining the current map view. For panning after clicking the pan button 1316, the user presses and holds a left mouse button while moving the map in the direction the user wants to pan. After releasing the mouse key, the map will redraw. FIG. 14a is a graphical screen depiction 1401 of a map of a provider coverage area in pan mode.

FIG. 14b is a graphical screen depiction 1403 of a map of a provider coverage area showing a zoom in area. Two buttons 1312 and 1314 with magnifying glasses are Zoom buttons. Using these buttons enlarges or shrinks the map view one step at a time. The “+” button enlarges the map view for a bigger view of the area (more square miles) and the “−” shrinks the map for a closer, more detailed look (fewer square miles). To use the buttons, a user may click on either button, and then click on the map. The map redraws, using the point where the user clicked as the center of the screen. FIG. 14c is a graphical screen depiction 1405 of a map of a provider coverage area showing the zoom in area after zooming in. FIG. 14d is a graphical screen depiction 1407 of a map of a provider coverage area showing a zoom level. FIG. 14e is a graphical screen depiction 1409 of a map of a provider coverage area showing the zoom in area of FIG. 14d, zoomed to a greater zoom level.

Radius buttons 1318 include dark circles. These buttons allow a user to go directly to the map view of choice, and are a quick way to jump multiple steps larger or smaller with just a click. A user may click any of the radius keys to immediately jump to a new view.

Two other buttons 1306 and 1308 on the Control button bar are to draw Geo Fences, as discussed below.

To the immediate right of the Control buttons is a Fleet/Vehicle List. As a user assigns telemetry devices to the user's fleet vehicles, the vehicles appear in this area. For each vehicle defined, the user will see a selection box, a vehicle icon, and a vehicle name or ID number

To perform any action with a specific vehicle the user may select it by clicking in its selection box. Once selected, a check mark will appear in the selection box to the left of the vehicle icon. By clicking on a selected vehicle with the right mouse button, there are several functions one can perform.

For example, a last known location request results in a display of a selected vehicle on the map at its last regularly reported location. An update location request enables a user to find the selected vehicle's current location and display it on the map. In this exemplary configuration, the selected vehicle must be within the provider's wireless coverage in order to report its current location.

An exemplary predefined trail query provides a list of the most recent data points reported by the vehicle. The number of points returned is dependent on the value set in mapping preferences under a title of “Tracking Points.” This feature will return data previously reported by the device according to the schedule or any ad hoc queries to the device.

An exemplary retrieve data request enables a user to set a schedule that automatically collects and transmits data from the user's vehicles. In some cases, however, the user may want to see more data on a vehicle than what has been scheduled. The retrieve data function enables the user to view all of the recorded vehicle data for a specified time period, e.g., within the last 72 hours. Depending on the user's settings, the data will appear in the table at the bottom of the screen and may also appear on the map. This request accesses device data that is not collected by the device schedule. Depending on the length of time specified and the location of the vehicle, the request may take an extended period of time to complete. If the device is out of coverage then the request will not be successful until the vehicle comes back into coverage.

An exemplary change icon settings request enables the user to change the picture icon that represents the selected vehicle. One may also change a GeoFence “in-fence” and “out-fence” colors from this request. A user profile may not allow the user to access this feature.

An exemplary view device properties request will take one straight to a manage device menu for the particular vehicle. Here the user can control how data is collected and reported for the vehicle.

An exemplary show current GeoFence request, if the vehicle the user is working with has a GeoFence, enables the user to click Show Current GeoFence to add the GeoFence objects on the map for the user to view. To remove the GeoFence objects from the map the user may simply right-click on the fence object and select Remove GeoFence. This will remove the GeoFence objects from the map but the GeoFence will still be active for the device.

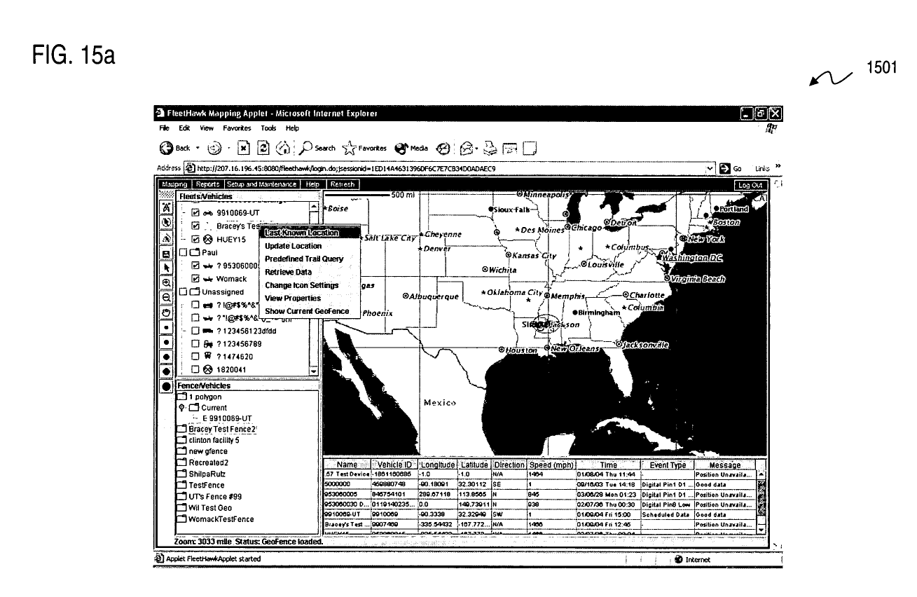

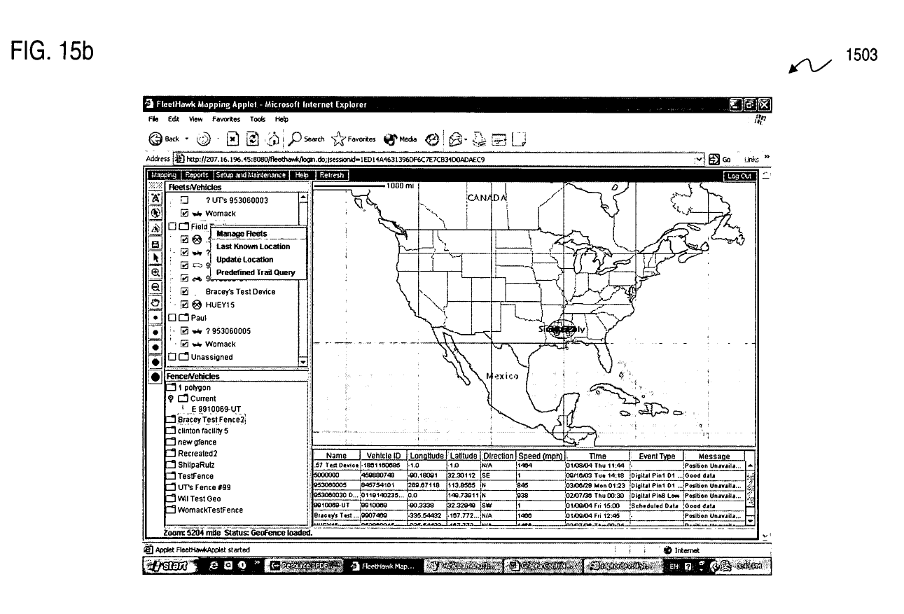

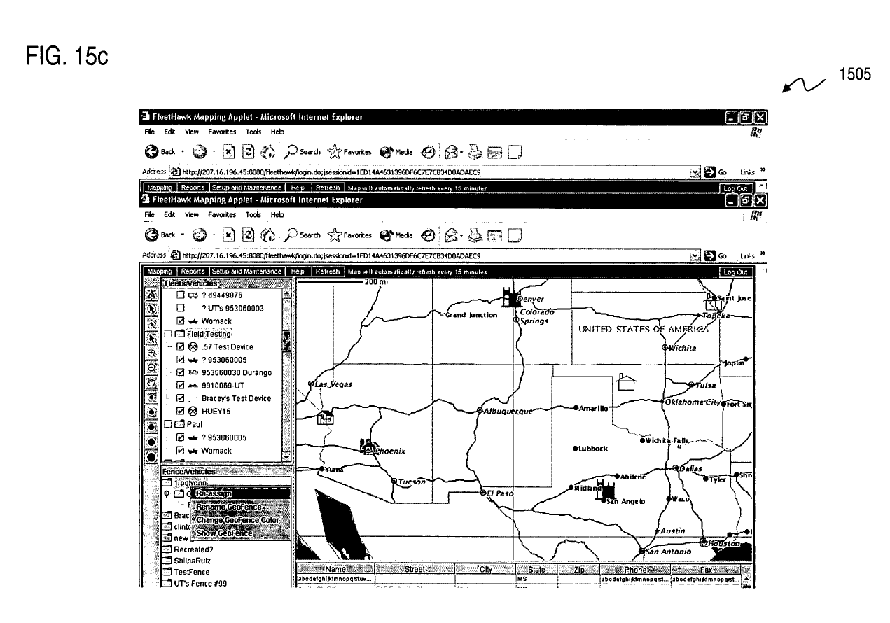

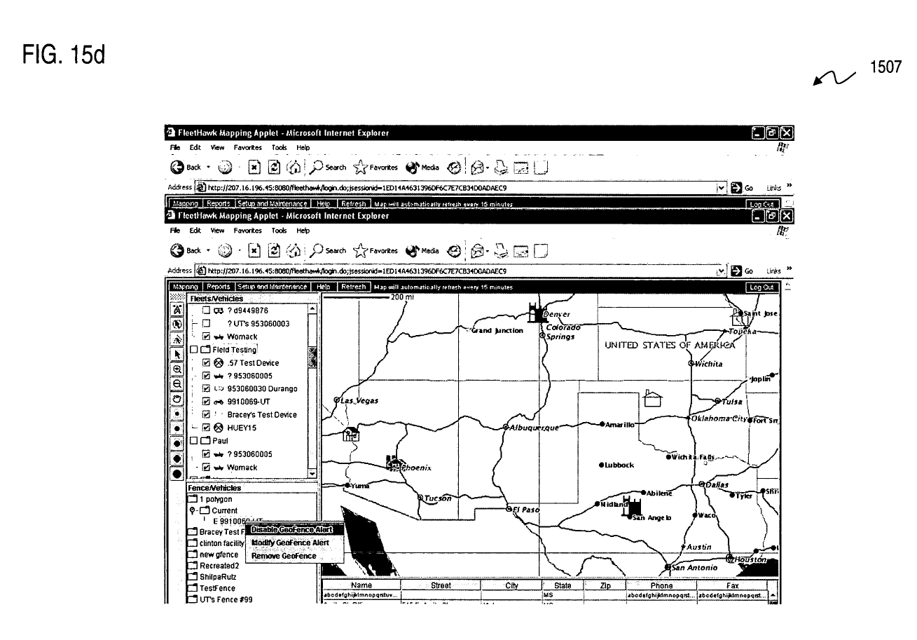

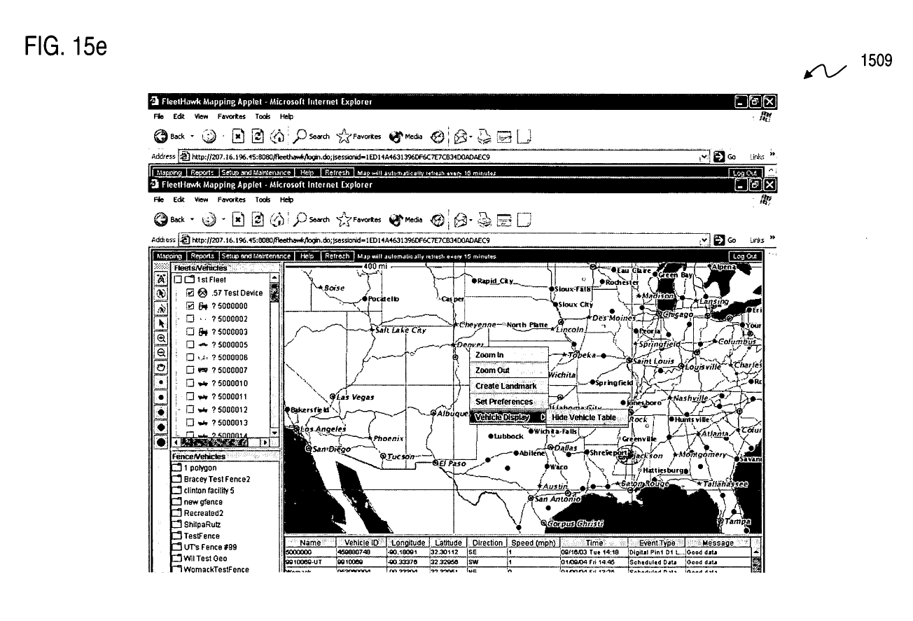

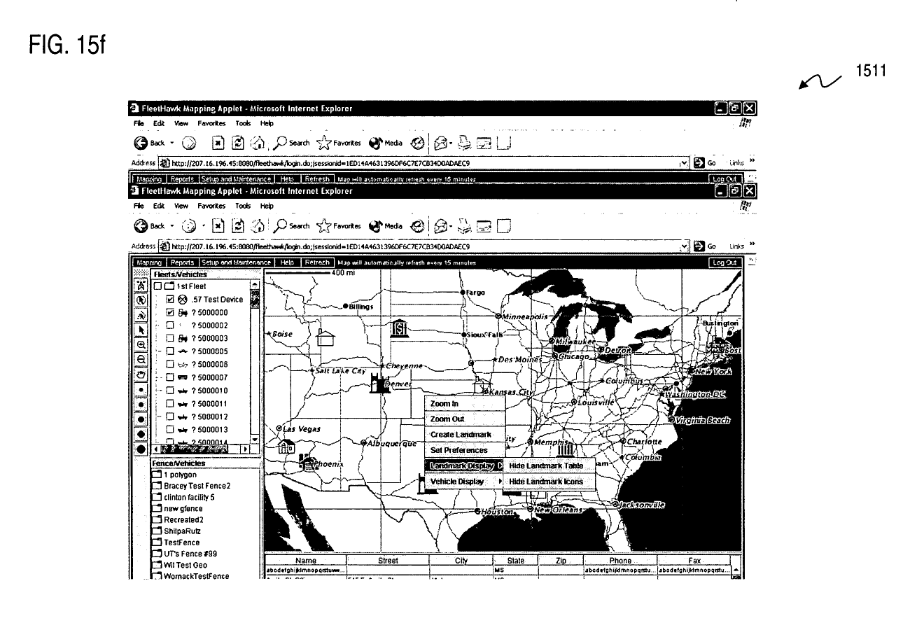

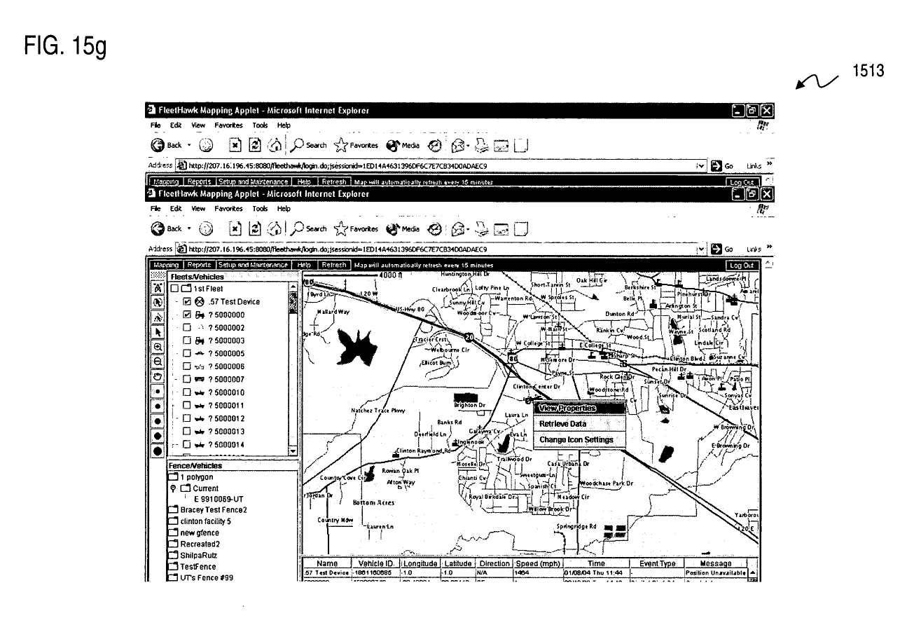

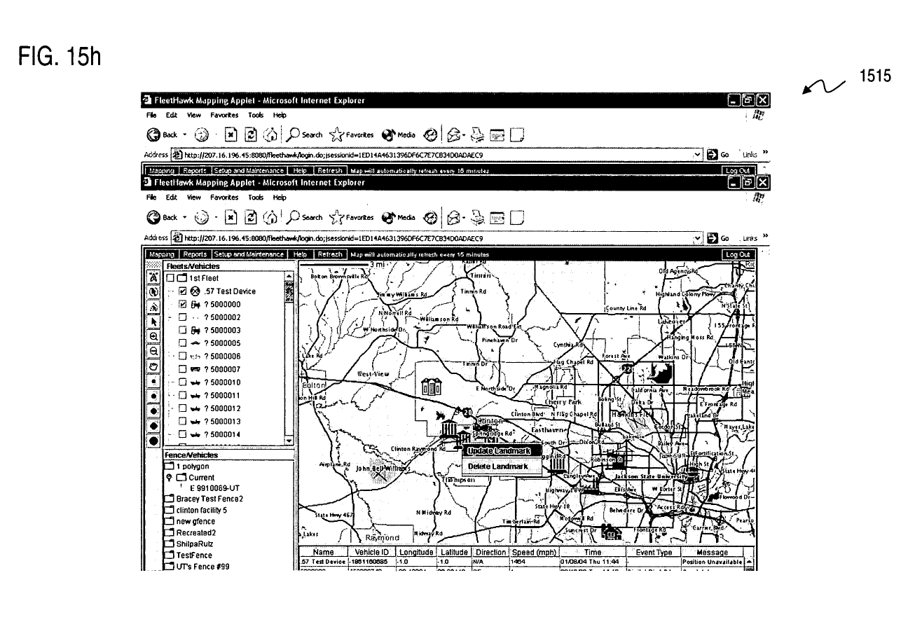

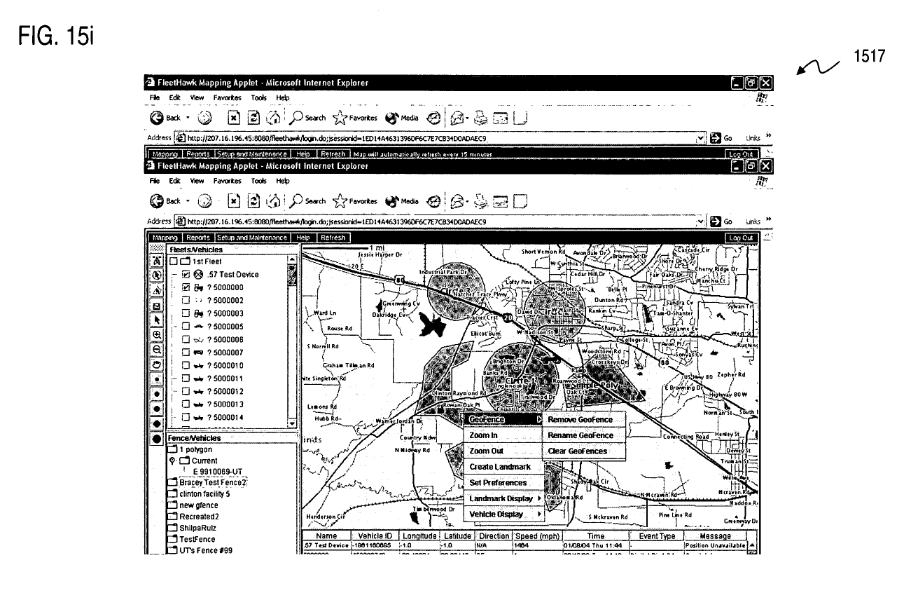

FIGS. 15a-15i show a variety of exemplary screens involving fleet and vehicle management. In particular, FIG. 15a is a graphical screen depiction 1501 of a map of a provider coverage area showing a pop up menu for a vehicle on a map. FIG. 15b is a graphical screen depiction 1503 of a map of a provider coverage area showing a pop up menu for a fleet on a map. FIG. 15c is a graphical screen depiction 1505 of a map area showing a pop up menu for a GeoFence group on a map. FIG. 15d is a graphical screen depiction 1507 of a map area showing a pop up menu for a device under a GeoFence group on a map. FIG. 15e is a graphical screen depiction 1509 of a map area showing a pop up menu for a device/vehicle on a map. FIG. 15f is a graphical screen depiction 1511 of a map area showing a pop up menu for a map including vehicles and landmarks. FIG. 15g is a graphical screen depiction 1513 of a map area showing a pop up menu available upon a mouse right click on a vehicle icon on the map. FIG. 15h is a graphical screen depiction 1515 of a map area showing a pop up menu available upon a mouse right click on a landmark icon on the map. FIG. 15i is a graphical screen depiction 1517 of a map area showing a pop up menu available upon a mouse right click on a GeoFence object icon on the map.

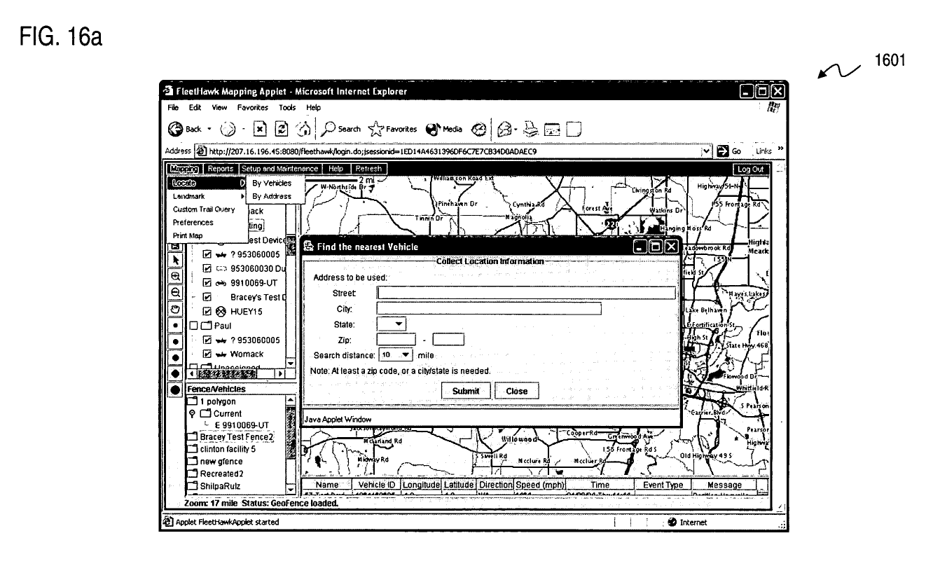

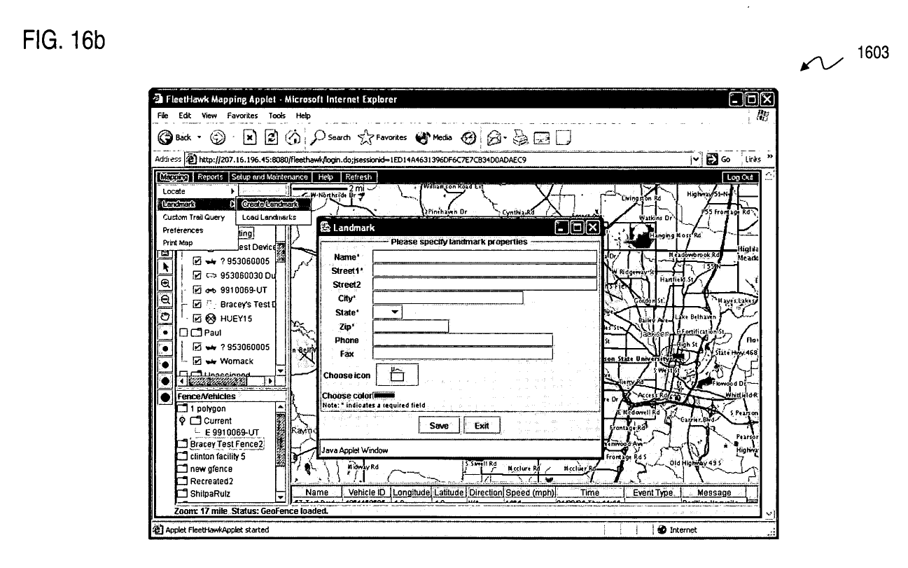

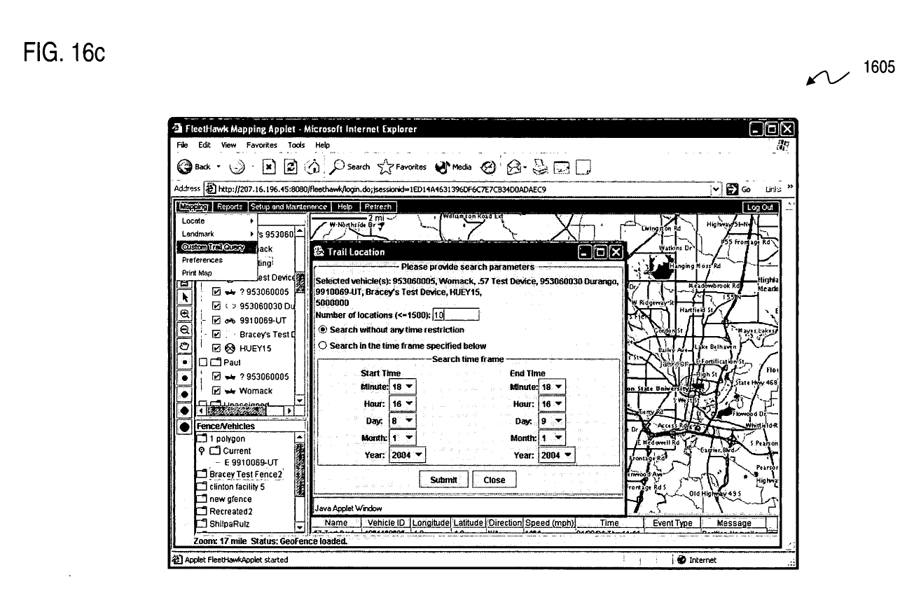

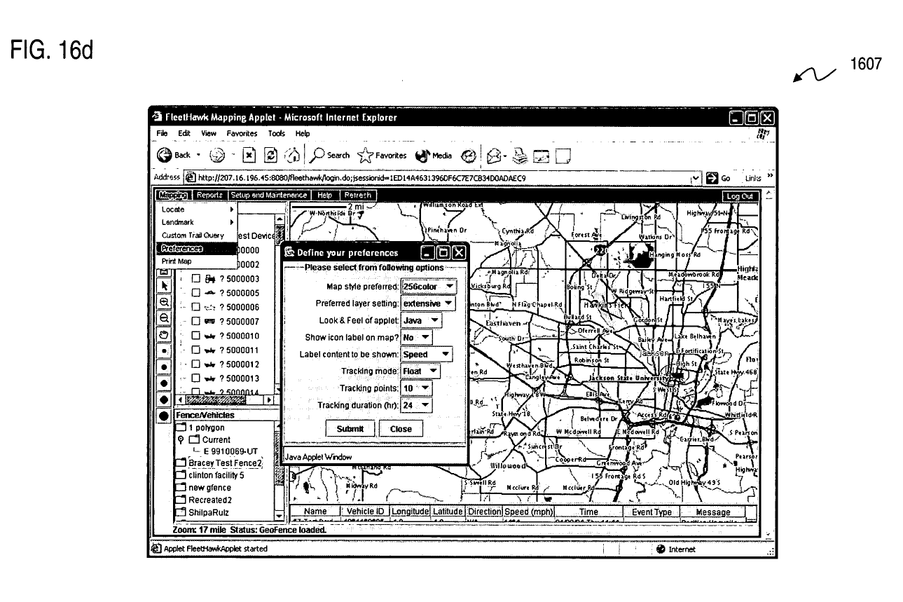

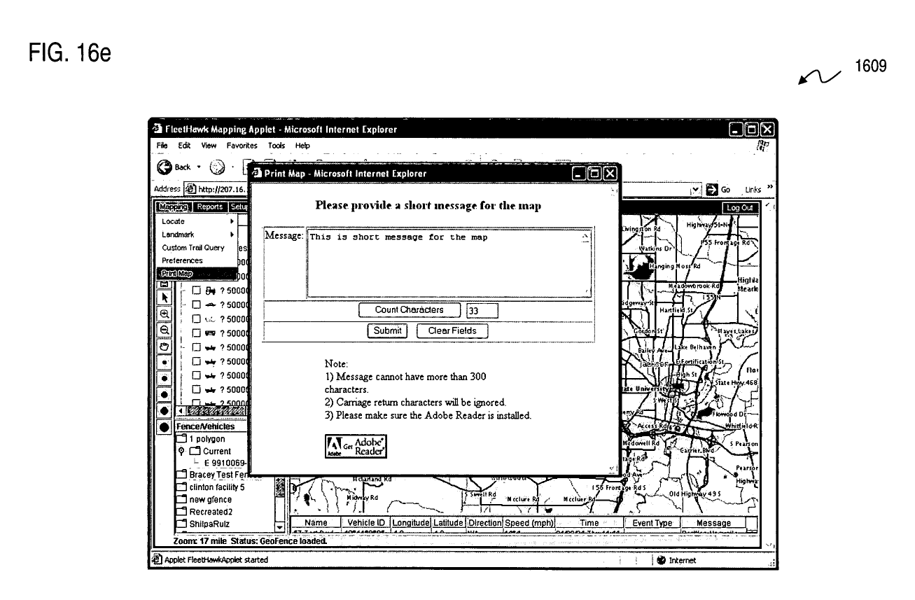

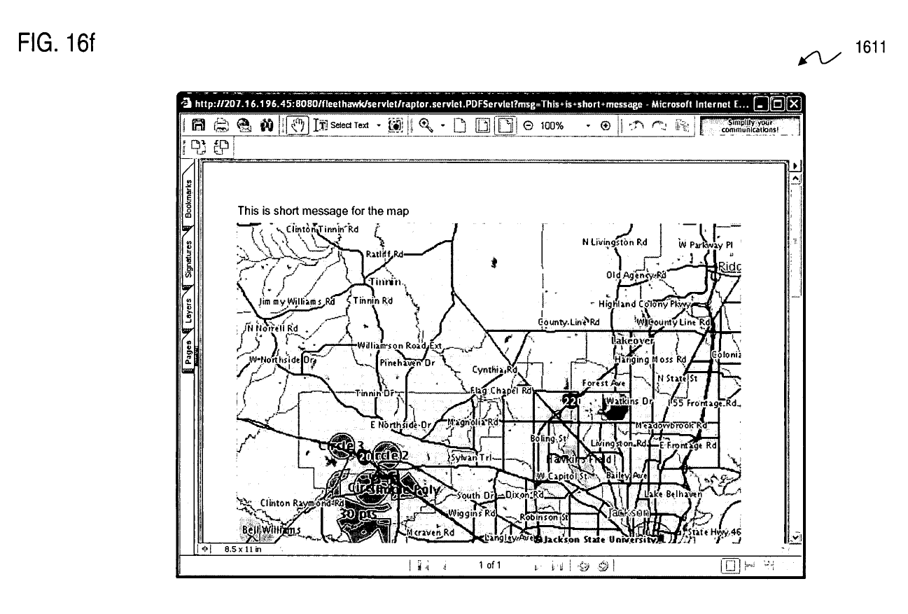

FIG. 16a is a graphical screen depiction 1601 of a menu displayed to collect address information for locating a vehicle nearest to the address. For this exemplary configuration, there are six buttons on the Main Menu, which appears at the top left of the screen. They are: Mapping, Report, Setup and Maintenance, Help, Log Out and Refresh. Exemplary functionality for the first three buttons is described below.

Clicking on Help will pull up a document the user is currently reading. Log Out ends the user's session, and Refresh will redraw the current map view with the most recent data from the selected vehicles(s).

Functions displayed under the Mapping button allow a user to perform actions defining how and what the user wants to view in the Map screen. The Locate functions will plot the last known location of specified vehicles. Multiple vehicles or fleets can be selected at once for viewing or updating location. Once a user initiates a Locate function, a data table will appear under the map containing the data for each point displayed. If the device was not able to determine position due to GPS interference then the message field in the data table will state “position unavailable.” This may occur if the device has lost power or if the GPS signal to the antenna is blocked.

Clicking the “Locate” menu option under Mapping reveals two options, as shown in FIG. 16a: Locate by Vehicles and Locate by Address.

Choosing Locate by Vehicles maps the specified vehicle(s) on the Map Screen. First, a user selects the vehicles in Fleet/Vehicle list by clicking on the corresponding check boxes next to the vehicle or fleet name. Then, a user selects the Locate by Vehicles function. The selected vehicles will appear on the map at their last reported location using, e.g., a distinctive vehicle icon. Vehicles may or may not still be at this location depending on when it last reported into the system. A user may choose Locate by Address to see all vehicles within a geographic area that the user has defined. The user may specify an address and radius, e.g., from 1 to 3,000 miles. The address specified will be at the center of the radius. The user may enter as much address information as he/she knows; a zip code or city/state combination is an exemplary minimum of information needed. As before, vehicles will display on the map at their last reported location using their distinctive vehicle icon.

A tracking request plots reported data locations of the selected fleet or vehicle according to a timeframe specified by the user. Before using this request, the user may select a vehicle in the Fleet/Vehicle list by clicking its selection box.

In one example, the user may choose Track from the menu, and then click on Customized Trail Query. The Trail Location screen will appear, where the user can set the parameters for the historical data the user wishes to retrieve. FIG. 16c is a graphical screen depiction 1605 of a menu displayed to collect information for initiating a trail query for tracking a vehicle. There may be several exemplary parameters: a Number of Locations parameter, which sets the number of data location points the user wants reported (in the exemplary configuration, no more than 500 data points can be reported); and a Search without any Time Restriction parameter, which retrieves the last number of data location points requested without any time boundaries.

An exemplary search in the time frame specified below option retrieves data location points within the time period that the user specifies. A number of locations setting still applies when searching a specified time frame, so the user may edit this setting accordingly.

A landmark option, as shown in FIG. 16b in screen depiction 1603, enables the user to create symbols on the map that correspond to customer locations, delivery stops or other important locations that the user wants to see on the map while viewing vehicles or assets.

The user may choose Create Landmark to specify properties for a new landmark. Once the user has this information he/she may simply fill out the form and choose a symbol and color for the landmark. The user may choose Load Landmark to view previously created landmarks on the map. The user may choose Remove Landmark to remove landmarks from the map the user is viewing. FIG. 16b is a graphical screen depiction 1603 of a menu displayed to collect address information for specifying a landmark.

The exemplary system allows a user to control the visual and time settings on the map screen. To access these settings, the user may click on Mapping, and then Preferences, as shown in a screen depiction 1607 in FIG. 16d. Map Style enables the user to choose the color scheme of the map. This will change the colors of labels, roads, and landmarks. Layer Settings lets the user choose the level of map detail. Extensive detail shows counties, cities, states, airports, schools, and churches. Moderate details shows counties, cities, states, but no landmarks. Simplified details show only major roadways with city and county boundaries.

A Tracking Mode parameter only affects mapping when the user is working with a vehicle that has a set data-reporting schedule. The user can set the Map Screen to be “Static” or “Floating.” If set to Static, the map view will not move as new data points arrive. If set to Float, the map view will reposition as new data points arrive.

A Tracking Points setting determines how many points will appear both on the map and in the data table for the vehicles that have been selected (working set). For example, if Tracking Points is set to five then any time a schedule is reporting or a trail query is executed then the user will see the five most recent points on the map for the working set selected.

A Tracking Duration setting is related to “Tracking Points” as discussed above. Instead of setting the number of points, the user may choose to select a time period for viewing the most recent points. For example, if Tracking Duration is set to two hours, then the user will always get the most recent two hours of data for the working set selected. Tracking Points and Tracking Duration settings may, in an exemplary implementation, work as either/or settings. For example, tracking the last five points or the last two hours, whichever comes first.

The user chooses the settings he/she desires for each of these parameters by left clicking the drop down menus for each. After setting parameters the user may click “Submit” in order for the new parameters to take effect. The new settings will be active when the user next logs in, or the user can click the browser's refresh button to see the new settings in the current session.

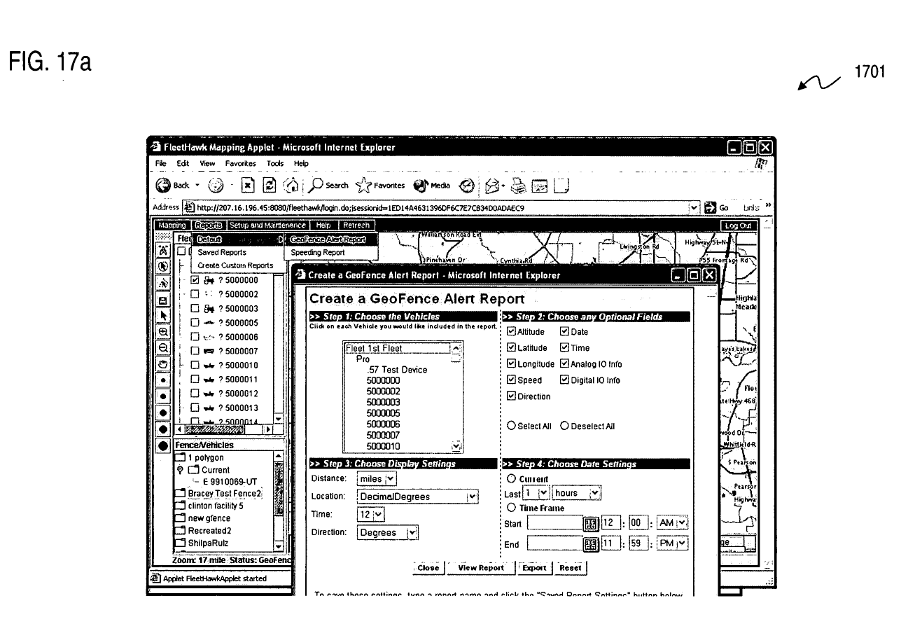

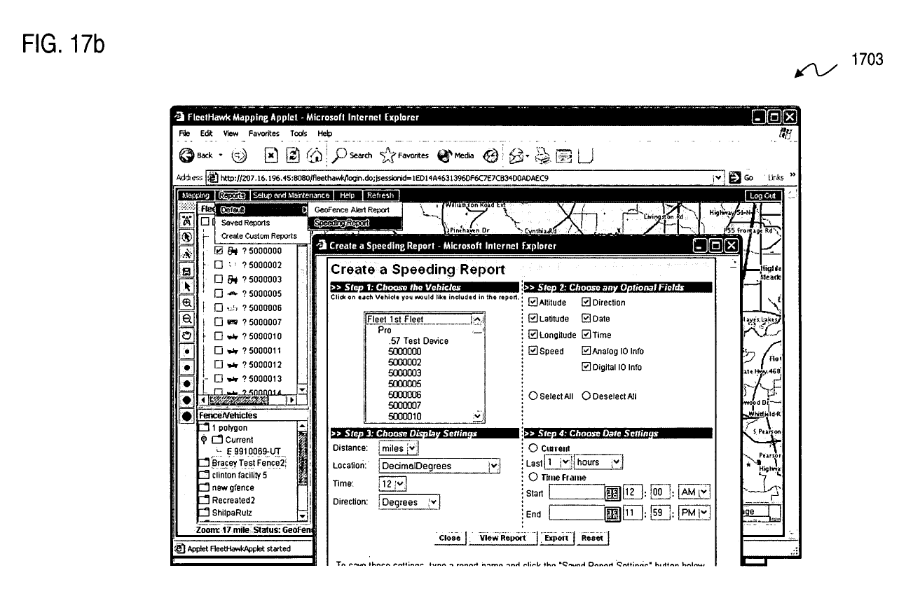

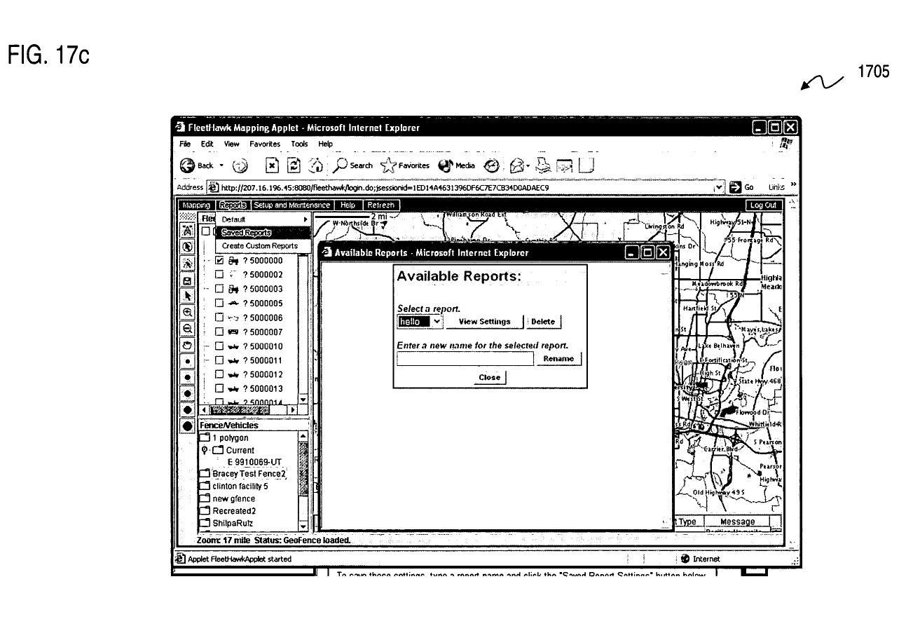

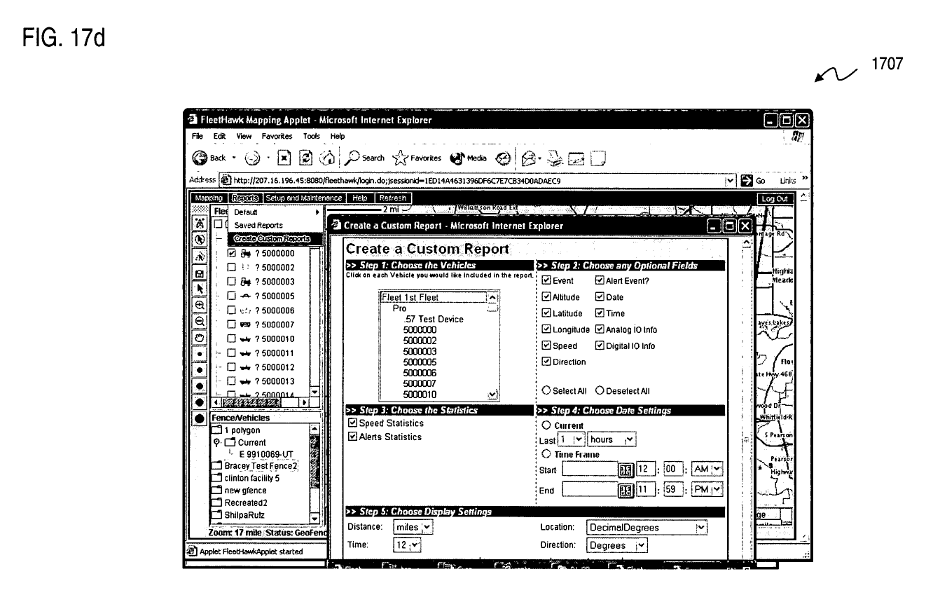

A Reports menu bar, as shown in FIG. 17a, enables the user to view historical information predefined (default) or custom reports. Typically this feature is used to access detailed data for specific time periods.

The exemplary system includes a GeoFence Violation Report. This report will detail each time a vehicle entered or exited a GeoFence set for that vehicle. It will also report the date, time, speed, direction, and location of the vehicle when the GeoFence was violated.

A Select Reports/Default/GeoFence Violation Report option enables the user to click on each vehicle he/she wishes to include in the report (in the “Select a Device” box). The user may choose one or multiple vehicles. To choose more than one vehicle, the user may hold down the “Ctrl”” key on the keyboard while clicking each vehicle one at a time. The user can also hold down the “Shift” key and click to select the first and last vehicle in a list; all vehicles in between the first and last selection will be selected for the report.

The user may choose a time frame for the report under “Data Settings.” The user chooses Current to view 1 to 24 hours in the immediate past. Or, the user may choose Time Frame to select a specific time period prior to that (as data is stored, e.g., for 45 days).

The user may click View Report for an onscreen display of data. If the report has more than one page, the user may click Next at the bottom to scroll to remaining pages of data. The user may click on a Statistics button on the report to view an organized summary of the report.

The user may click Export to create a text file that can be viewed in the application of the user's choice.

FIG. 17b is a graphical screen depiction 1703 of a menu displayed to collect information indicating a user preference for information to be included in a speeding report. A speeding report option provides a list of instances when the speed values set for a vehicle were exceeded. A user can choose exemplary specific time periods for the report. Vehicle ID, date, time, speed, direction, location, threshold crossed, and speed status may be reported.

The user may select Reports/Default/Speeding Report from a menu. In the selection screen that appears, the user may click on each vehicle the user wishes to include in the report. The user may choose one or multiple vehicles. To choose more than one vehicle, the user may hold down the “Ctrl” key on the keyboard while clicking each vehicle one at a time. The user can also hold down the “Shift” key and click to select the first and last vehicle in a list; all vehicles in between the first and last selection will be selected for the report.

The user may choose a time frame for the report under “Data Settings.” The user may choose Current to view 1 to 24 hours in the immediate past. Or, the user may choose Time Frame to select a specific time period prior to that (data is stored, e.g., for 45 days).

The user may click View Report for an onscreen display of data. Each line of the report will have a Speed Status of either “Set” or “Clear.” “Set” indicates the vehicle exceeded the speed parameter; “Clear”” indicates the vehicle fell below the speed parameter. If the report has more than one page, the user may click Next at the bottom to scroll to remaining pages of data. The user may click on the Statistics button at the bottom of the report to view an organized summary of the report. The user may click Export to create a text file that can be viewed in the application of choice. For example, FIG. 16e is a graphical screen depiction 1609 of a menu displayed to collect information indicating a user preference for printing a map. FIG. 1611 is a graphical screen depiction of a map printed in pdf format resulting from the preference provided in FIG. 16e.

The exemplary system enables a user to create custom reports as needed. FIG. 17c is a graphical screen depiction 1705 of a menu displaying available reports. FIG. 17d is a graphical screen depiction 1707 of a menu displayed to collect information indicating a user preference for information to be included in a custom report. The user may click on Reports/Create to begin. The user may click on the vehicles he/she wants to include in the report. The user may choose one or multiple vehicles. To choose more than one vehicle, the user may hold down the “Ctrl” key on the keyboard while clicking each vehicle one at a time. The user may also hold down the “Shift” key and click to select the first and last vehicle in a list; all vehicles in between the first and last selection will be selected for the report.

Optional Fields selections allow the user to indicate the data for the report. The list includes all of the data collected by the exemplary system. To include a data item, the user may click in its selection box. To include all available data, the user may click Select All. The user may click Deselect All to clear all items. The user should select at least one data field for the report.

The exemplary system can provide overview Speed and Alert statistics that summarize the data in the report. The user may click in summary statistics selection boxes to include these summary calculations.

A Date Settings option enables the user to choose the time span for the report.

The user may also customize the formatting of distance, time, and location data displays. To run the report the user may click View Report for an onscreen display of the data. If the report has more than one page, the user may click Next at the bottom to scroll to remaining pages of data. The user may click on the Statistics button at the bottom of the report to view an organized summary of the report. The user may click Export to create a text file that can be viewed in the application of choice.

To save custom report settings the user may type a name for the report in the Saved Report Name field. The user may then click on a Save Report Settings button.

The exemplary system allows a user to retrieve custom reports saved using the Save Report Settings.

The user may choose Reports/Saved from a Retrieving/Modifying Saved Reports menu. The user may click on the drop down menu to reveal a list of saved reports. The user may select the report he/she wants to retrieve or modify, and click the “Get Report Settings” button to view the saved settings. The user may follow the steps outlined under Create Reports to rerun or modify the saved report.

The user may rename or delete a saved report by selecting Reports/Saved from the menu. The user may choose the report from the drop down box at the top. To rename it, the user may type the new name in the field provided, and then click the Rename button. To delete the report, the user may simply click on the Delete button after selecting a report from the drop down list.

The user may use the Setup and Maintenance functions to organize the exemplary system to meet specific needs. Options here allow the user to group vehicles into fleets, edit system user authority levels, and customize the way telemetry devices record and transmit data.

The exemplary system's service provides an easy way to manage and group vehicles into fleets. For example, the user may have vehicles that belong to Eastern, Western, Southern, and Northern operations. Or perhaps the user has a Service fleet and a Delivery fleet. Grouping the vehicles as fleets allows the user to view data by fleet, control data collection parameters by fleet, and compare performance between fleets.

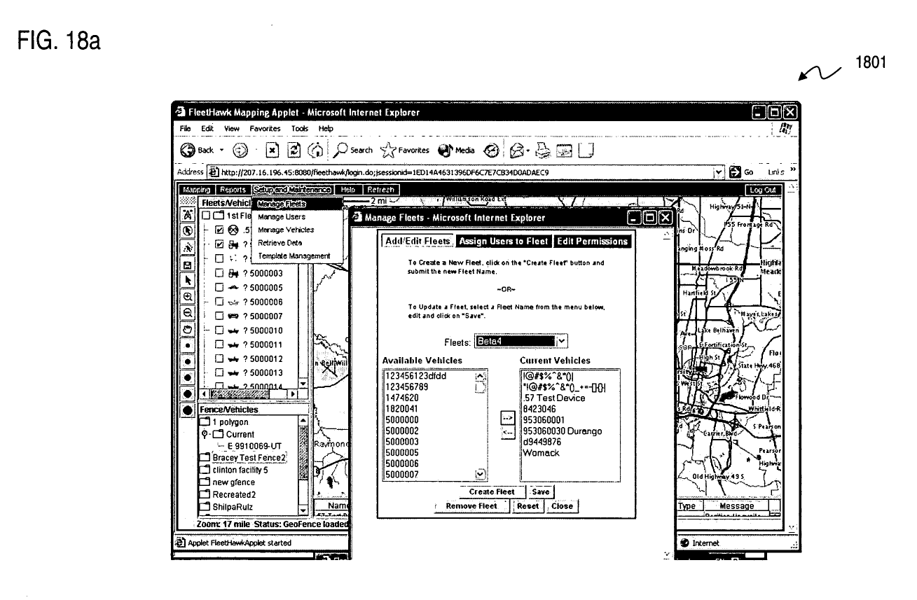

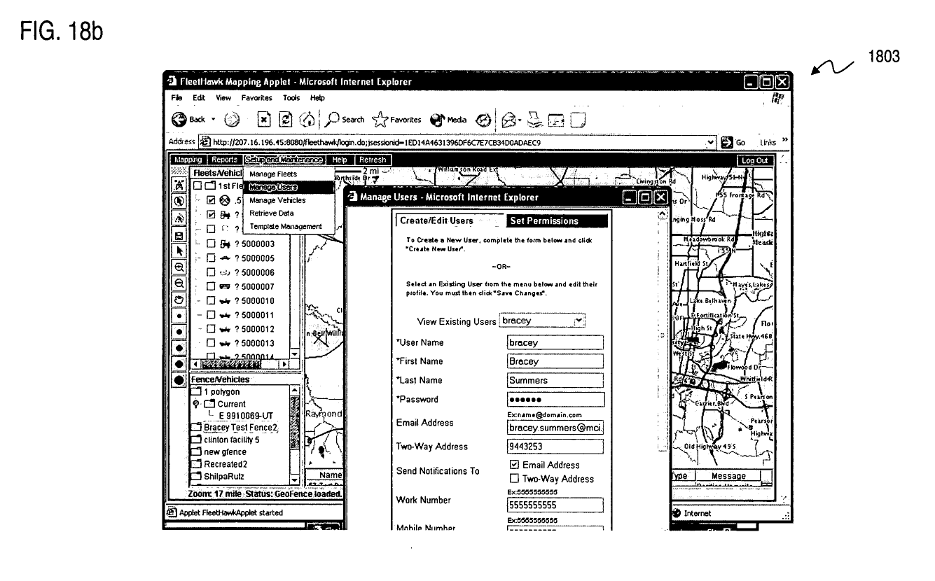

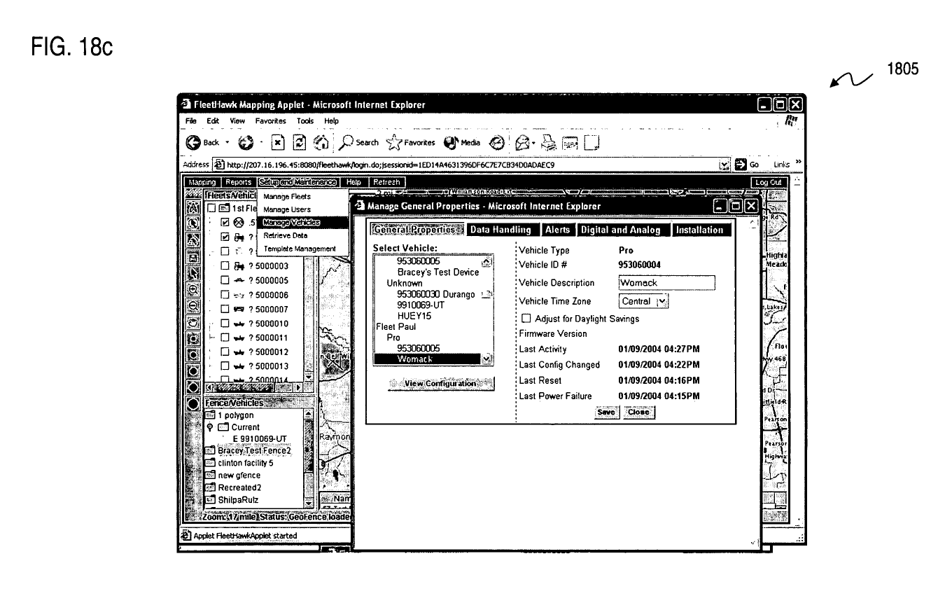

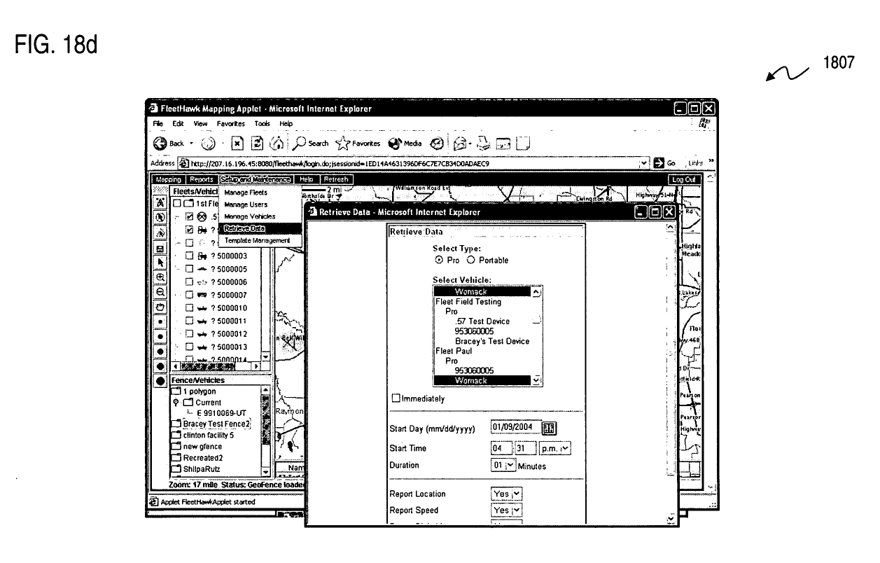

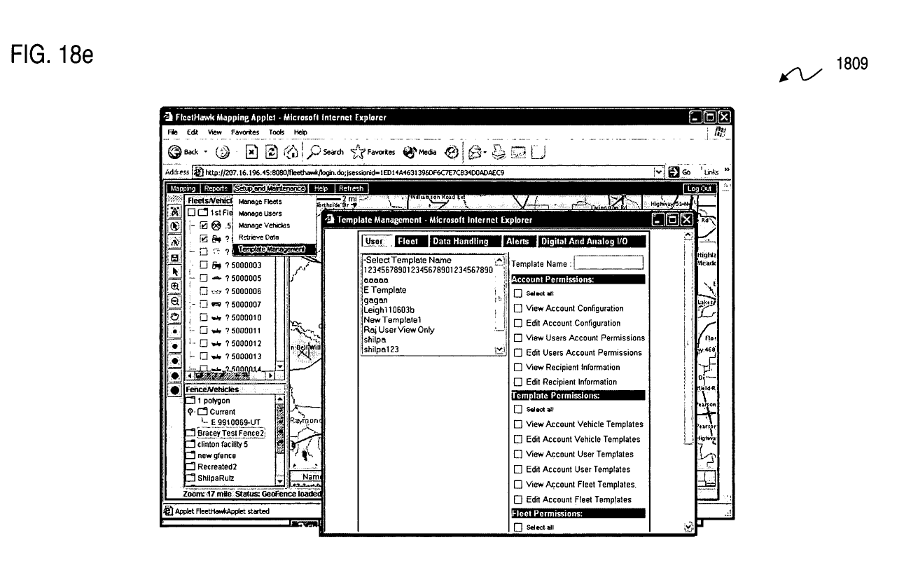

FIG. 18a is a graphical screen depiction 1801 of a menu displayed to enable a user to assign vehicles to fleets, according to an embodiment of the present invention. FIG. 18b is a graphical screen depiction 1803 of a menu displayed to enable a manager to create users and set permissions, according to an embodiment of the present invention.

The user may go to a Setup and Maintenance/Manage Fleets option. In the screen that opens, the user may see three exemplary menu options: Add/Edit Fleets enables the user to create fleets or add and remove vehicles from fleets, Add Users to Fleets enables the user to select users to view the fleet group, and Edit Permissions enables the user to set authority levels for the users who can view the fleet group. These options allow the user to add new telemetry system users and edit permission profiles for existing users.

The user may go to a Setup and Maintenance/Manage Users option. In the screen that opens, the user will see two menu options: Add/Edit Users allows the user to enter new users or edit contact information for existing users. To add a new user the user may fill in the required information and click “Save.” The new user will appear in the user list at the top of the form. The user may make sure to give the new user the account name, user ID and password so they can access the system. The second option, Set Permissions enables the user to control system authority levels for users

FIG. 18c is a graphical screen depiction 1805 of a menu displayed to enable a manager to manage vehicles. FIG. 18d is a graphical screen depiction 1807 of a menu displayed to enable a user to request retrieval of data from a device.

Manage Vehicles options allow the user to customize how data is collected and reported on the telemetry devices. For example, the user may go to a Setup and Maintenance/Manage Vehicles option. In the screen that opens, the user will see four menu options: General Properties allow the user to enter and edit the name of the vehicles on which the user has installed devices. This tab will also show the user the serial numbers of devices. Data Handling allows the user to control when and how often data is collected, set a schedule and enable or disable the schedule. An Alerts feature enables the user to set alerts, and enter and edit individuals that will be notified in event of speeding “events.”

A Digital and Analog I/O option enables the user to control the settings for custom installations that can interact with a vehicle's electrical systems, e.g., to monitor temperature, open and close door locks.

A Retrieve Data request enables the user to access data not originally captured with the schedule the user set up. This request will go to the device and return data such as location and speed for the time interval specified. This feature is commonly used to get historical data (e.g., up to 72 hours) directly from the device in the event the schedule was disabled or did not capture the specific time period in which the user is interested.

The user may go to a Setup and Maintenance/Retrieve Data option on the menu. In the screen that opens, the user may click on the vehicle, or vehicles the user wants to query. Next, the user may decide to query for data that is: Immediate (at time of receipt of request) or a point of time in the past with, e.g., up to 60 minutes of data readings immediately thereafter.

Other options enable the user to select or deselect, e.g., speed and location data. The user may click on “Send” to submit the query. The exemplary system will send an immediate over the air message to the vehicle requesting the data. Depending on the settings, the results may appear in the Data Table and on the map of the system screen. The vehicle should be within provider coverage in order to respond.

System telemetry devices may have limited data storage capacity. For example, a device may hold around 72 hours (3 days) of recorded data. Data older than 72 hours thus may not be available using this feature. The user may thus set a schedule that captures the data needed on a daily basis and use the Retrieve Data function as an exception tool, instead of as a regular reporting tool.

The exemplary system gives the user control of a large number of system parameters for both user permissions and data management. To use the same set of parameters for multiple users and devices, the user may create templates to store the setups used most often.

FIG. 18e is a graphical screen depiction 1809 of a menu displayed to enable a user to manage templates.

The user may click on Setup and Maintenance/Template Management. In the screen that appears, the user will see five template options: User creates templates for user permission levels), Fleet builds templates for fleet permission levels, Data Handling creates templates for setting device data collection parameters, Alerts creates templates for notification procedures for device events, and Digital/Analog I/Os creates templates for pin settings on devices. The user may use these template management tools to make customization of the telemetry system quick and easy.

FIG. 17a is a graphical screen depiction 1701 of a menu displayed to collect information indicating a user preference for information to be included in a GeoFence alert report. A GeoFence may be an enclosed geographic boundary that the user defines and applies to any number of fleets or vehicles. Using GeoFences, the exemplary system will record each time the vehicle(s) enters or exits the boundaries of the GeoFence. These “events” can also, e.g., trigger the system to send alerts to provider pagers or email.

The exemplary telemetry system allows the user to create and view current GeoFences; however, the user's user profile may not allow the user to create GeoFences. A GeoFence, e.g., may be a collection of up to 32 separate defined areas (GeoFences) on the map.

Depending on the user profile, the user may be able to create GeoFences for one or a group of vehicles. Each vehicle can be assigned to one GeoFence; however, a GeoFence may be made up of, e.g., up to 32 individual GeoFence objects. To create a GeoFence, the user may select the vehicle or vehicles theuser wants to work with on the Fleet List. More than one vehicle can be selected. Next, the user may click on Mapping/GeoFences/Create Fence. Two extra buttons 1306 and 1308 are shown as control buttons on the left side of the screen 1302.

The user may click the button 1306 to draw a circular GeoFence. The mouse is then in GeoFence mode. The user may move the mouse cursor onto the Map screen. The user may place the cursor exactly where the user wants to start the middle of the circle. The user may hold down the left button on the mouse as the radius of the circle is dragged outward. The user may release the mouse key when the circle is complete, and the inside of the circle becomes shaded. If the user is not pleased with the GeoFence, the user may click on it with the right mouse button, and choose delete.

The user may click the button 1308 to draw an irregular polygon-style GeoFence. The mouse will convert to GeoFence mode. The user may move the mouse cursor onto the map. The user may place the cursor on the first boundary point where the user wants to begin drawing. The user may click the mouse once to set the beginning point. The user may click again at the next boundary point and see a straight line from the first to the second point. The user may continue to click on the map to define the fence shape. When the user clicks again on the first point the user completes the fence boundary. For this example, up to 32 direction changes, or nodes, are allowed. Once the shape is completed, the inside of the shape becomes shaded. As before, if the user is not pleased with the shape, the user may click on the shape with the right mouse button, and choose delete.

To rename a GeoFence the user may right click on the GeoFence folder and choose the Rename GeoFence option.

Directly under the Fleet/Vehicle list, the user will see a list of the GeoFences that have been created for vehicles or fleets on the account. The user may also view the devices that are assigned to the GeoFence he/she is viewing by expanding the GeoFence folder. The level below the GeoFence folder shows up to two sub-folders for current and pending “fences.” Each time a GeoFence is applied to a device, the GeoFence settings are sent to the device via the provider network. Vehicles in the Current folder are vehicles on which the GeoFence has been successfully applied, and the GeoFence is active. Vehicles in the Pending folder are vehicles on which the GeoFence setting has not been confirmed. Once the vehicle confirms receipt of the GeoFence setting the vehicle will be moved from the Pending folder into the Current folder, showing that the GeoFence is now active.

Right clicking on a GeoFence folder displays several options for the GeoFence the user is working with. These options are: Assign To Device (vehicle), Rename GeoFence, Change GeoFence Color, and Load GeoFence. If the user chooses Load GeoFence the map screen will recenter over the GeoFence the user is currently working with. The GeoFence or GeoFences will appear as shaded areas on the map of the user. The user may delete a GeoFence by right clicking on it and choosing delete, and then clicking on Yes. If the user is unable to perform this action then the user profile may not be authorized to edit GeoFences.

In distinguishing the Locate, Update Location, and Retrieve Data commands, it is pointed out that, in an exemplary implementation, the three commands are similar in that they all request a quick reading on a vehicle. However, the Locate command provides a reading of the latest reported data point from the provider servers (these servers store scheduled telemetry device updates, based upon the reporting schedule the user has set for the device). The Update Location command sends an over-the-air query to the vehicle to retrieve the very latest single data point stored inside the device. The user is directly providing the query of the device with this command. As such, this command can give the user the timeliest information on the vehicle. The Retrieve Data command sends an over-the-air query to the vehicle to retrieve multiple data points stored inside the device, typically based on a time range the user specifies.

Additionally, a user may turn off reporting and data collection associated with a particular by changing the Data Handling parameters under Manage Vehicles to “Off.”

The exemplary system described above may offer many advantages to a user, including, but not limited to aiding in dispatching decisions, ensuring route adherence, preventing personal use of company vehicles, recovering stolen vehicles/assets, being a new source of delivery information for a user's customers, providing evidence in legal proceedings, and availability as a coaching and disciplinary tool for managers.

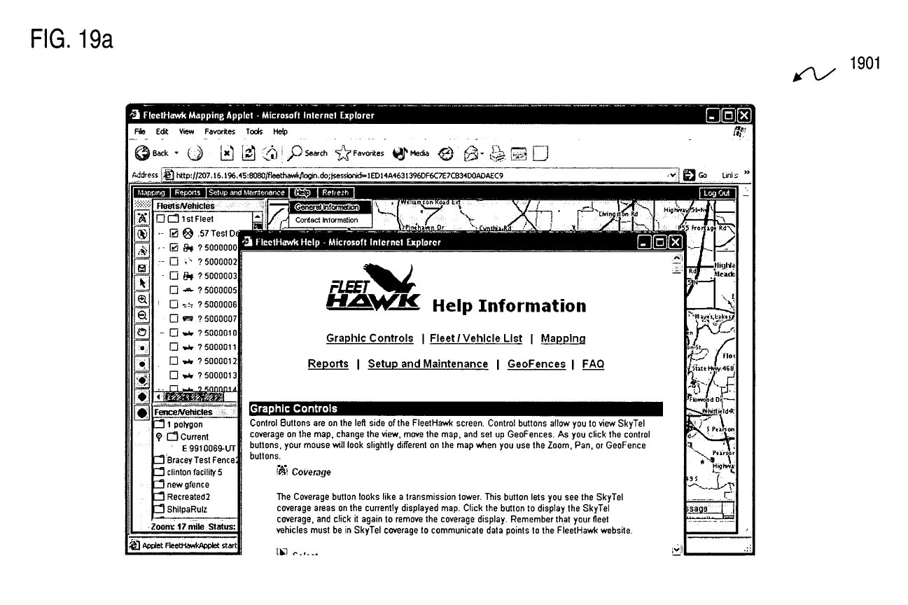

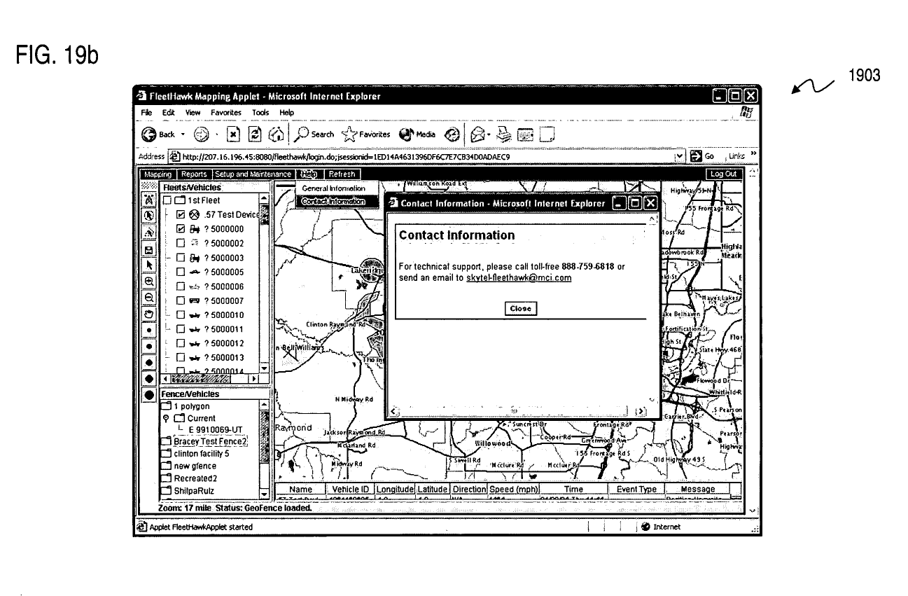

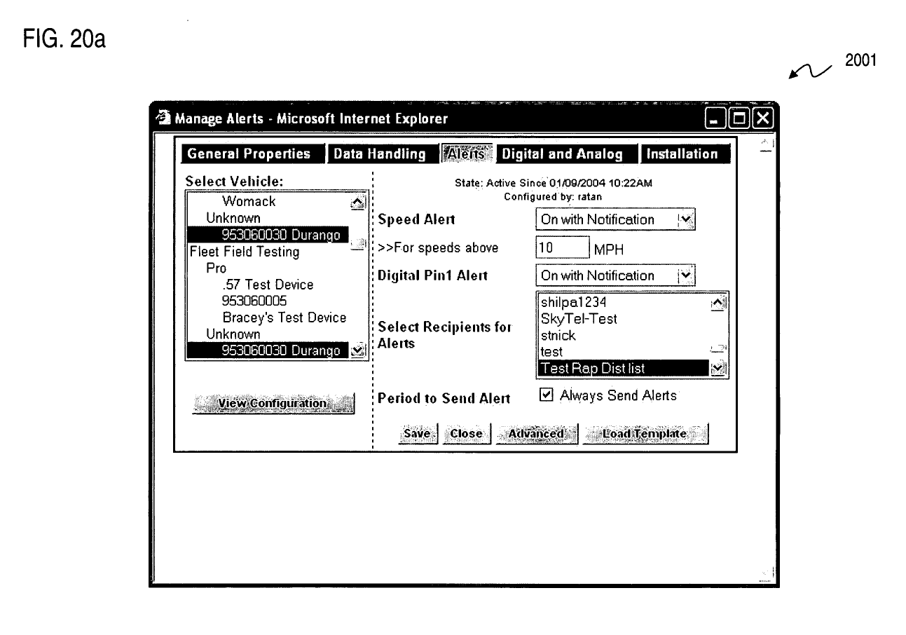

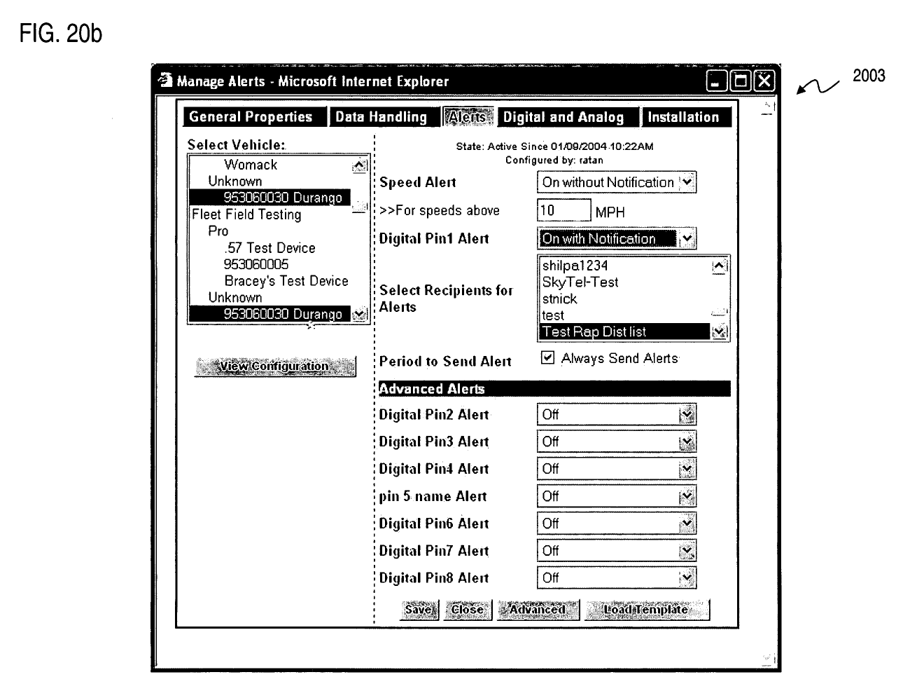

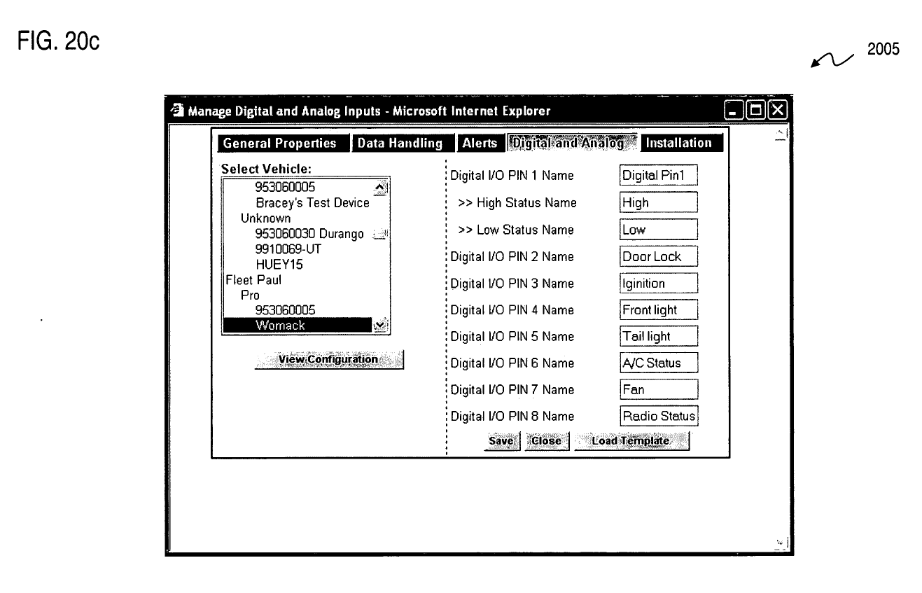

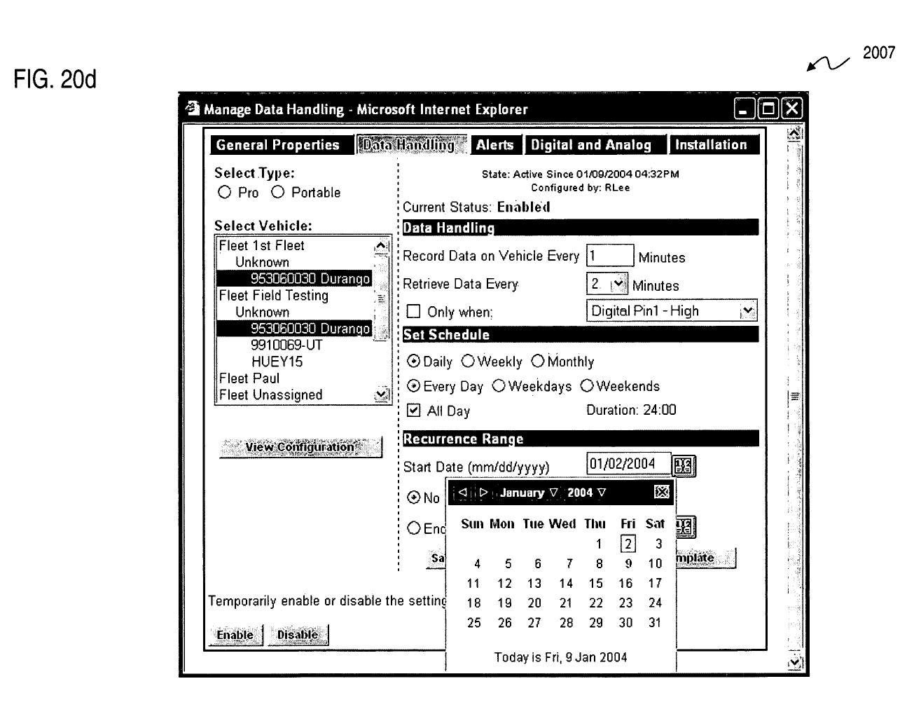

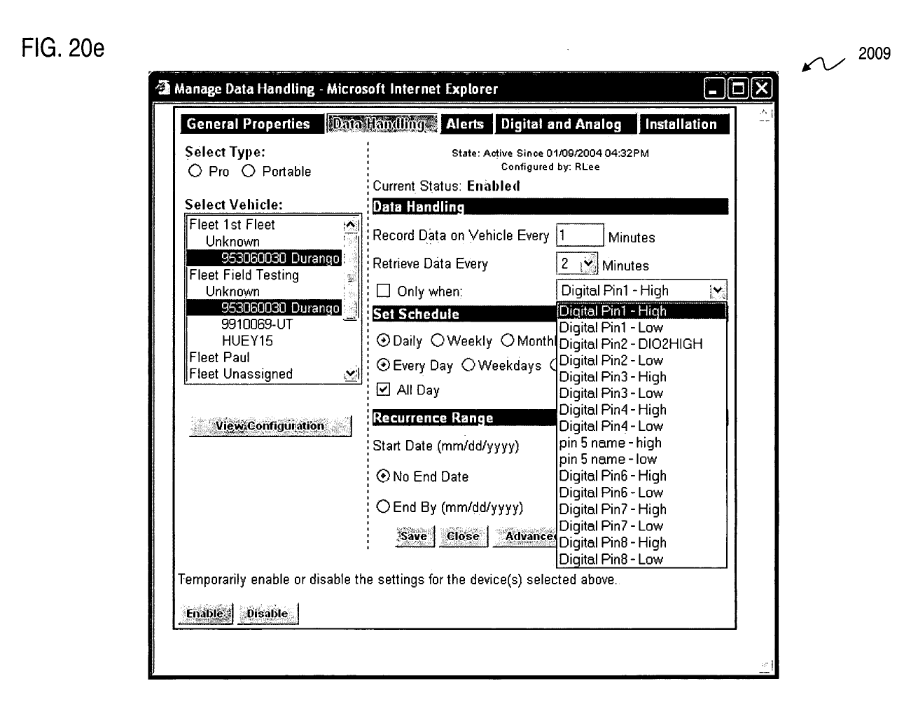

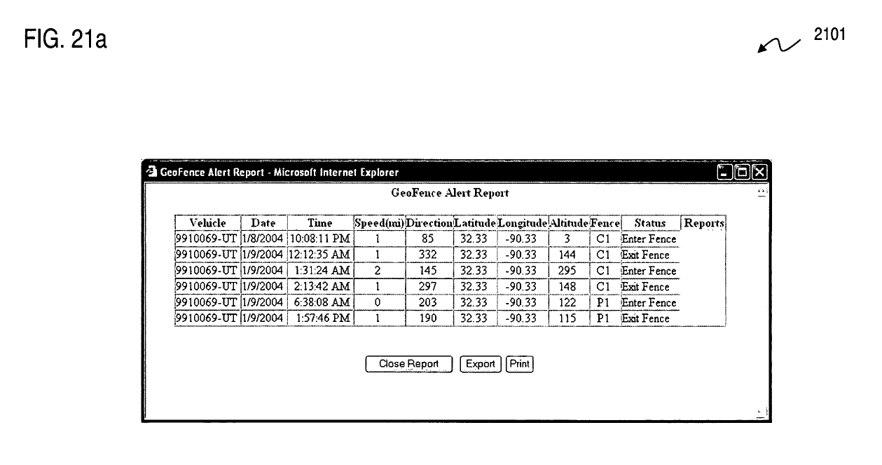

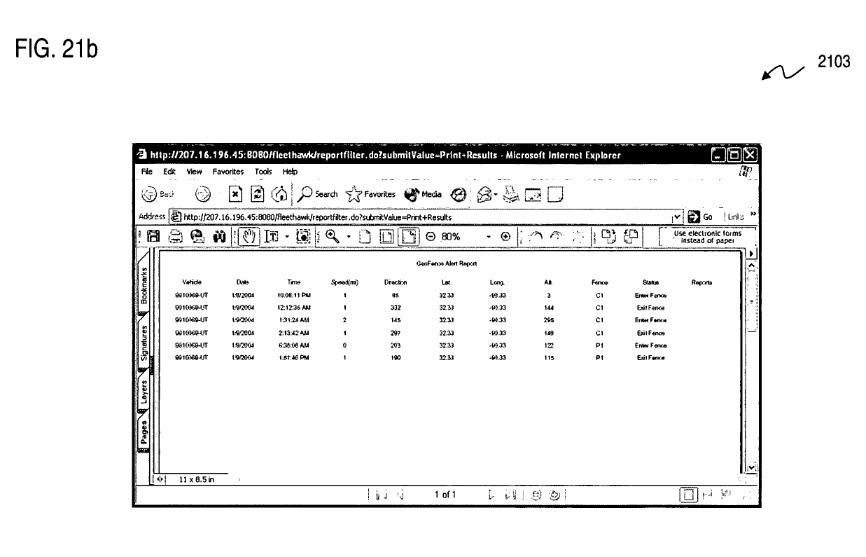

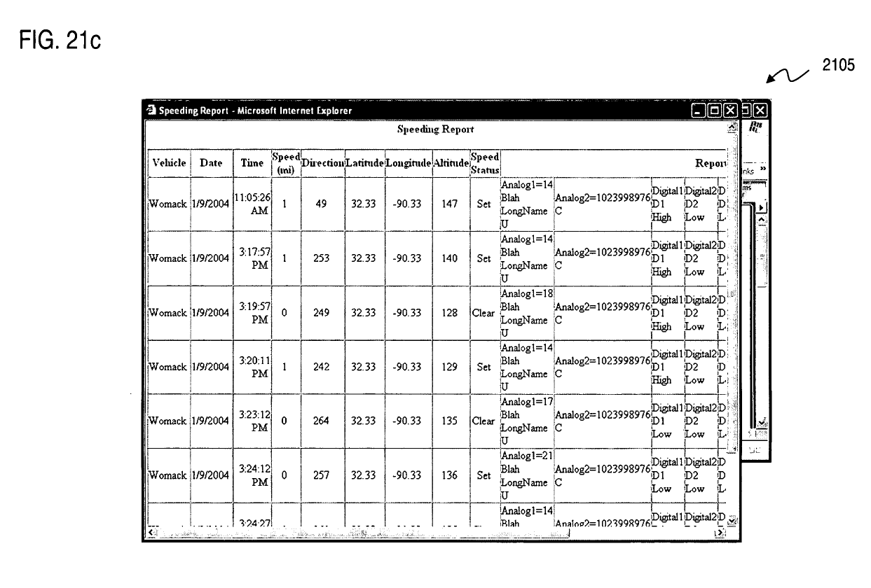

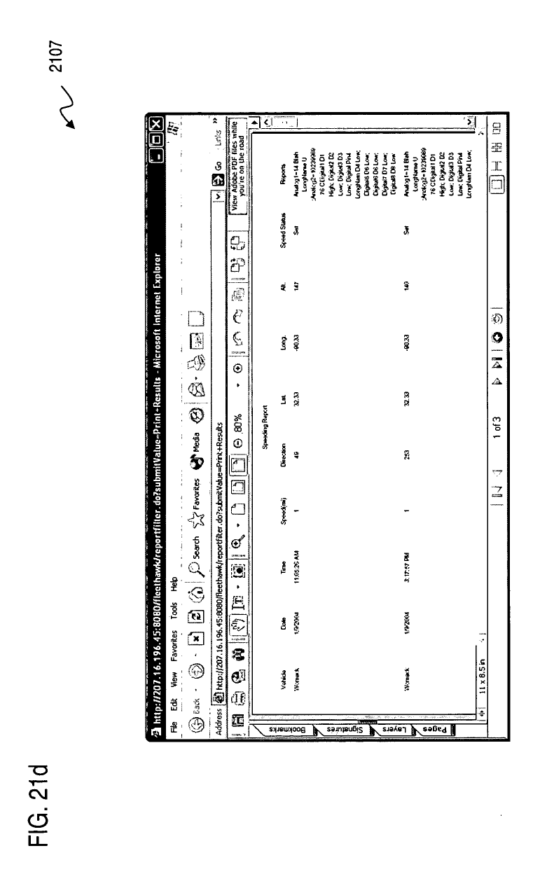

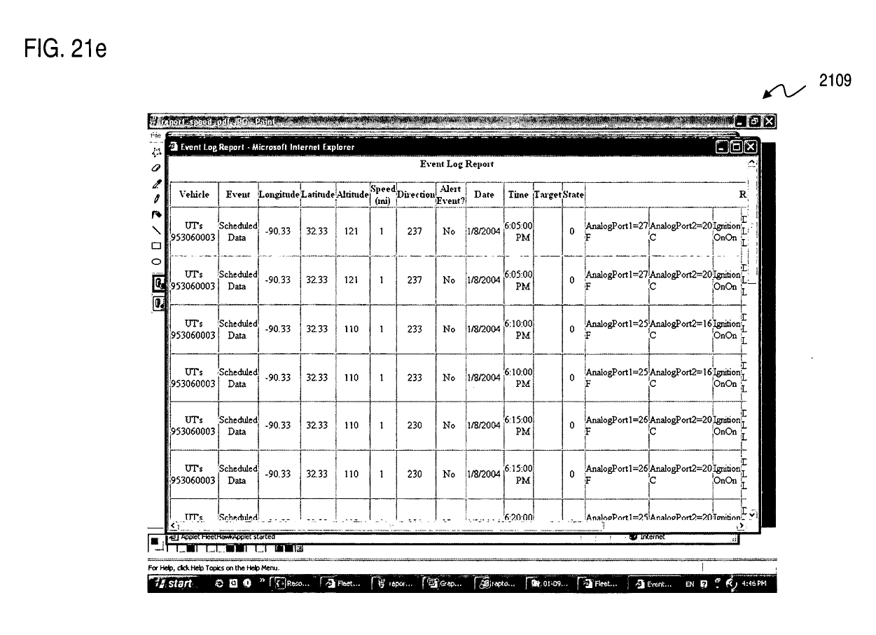

Further graphical screen depictions included in the exemplary system implementation are provided in FIGS. 19-21. Specifically, FIG. 19a is a graphical screen depiction 1901 of user help information. FIG. 19b is a graphical screen depiction 1903 of contact information. FIG. 20a is a graphical screen depiction 2001 of a form displayed to collect information indicating a user preference for information to be collected regarding alerts. FIG. 20b is a graphical screen depiction 2003 of a form displayed to collect information indicating a user preference for information to be collected regarding alerts. FIG. 20c is a graphical screen depiction 2005 of a form displayed to collect information indicating a user preference for information to be collected regarding alerts associated with digital and analog inputs. FIG. 20d is a graphical screen depiction 2007 of a form displayed to collect information indicating a user preference for device data handling. FIG. 20e is a graphical screen depiction 2009 of a form displayed to collect information indicating a user preference for device data handling. FIG. 21a is a graphical screen depiction 2101 of a GeoFence alert report. FIG. 21b is a graphical screen depiction 2103 of a PDF version of the GeoFence alert report shown in FIG. 21a. FIG. 21c is a graphical screen depiction 2105 of a speeding report. FIG. 21d is a graphical screen depiction 2107 of a PDF version of the speeding report shown in FIG. 21c. FIG. 21e is a graphical screen depiction 2109 of an event log report generated in response to a request for device data in a custom report.

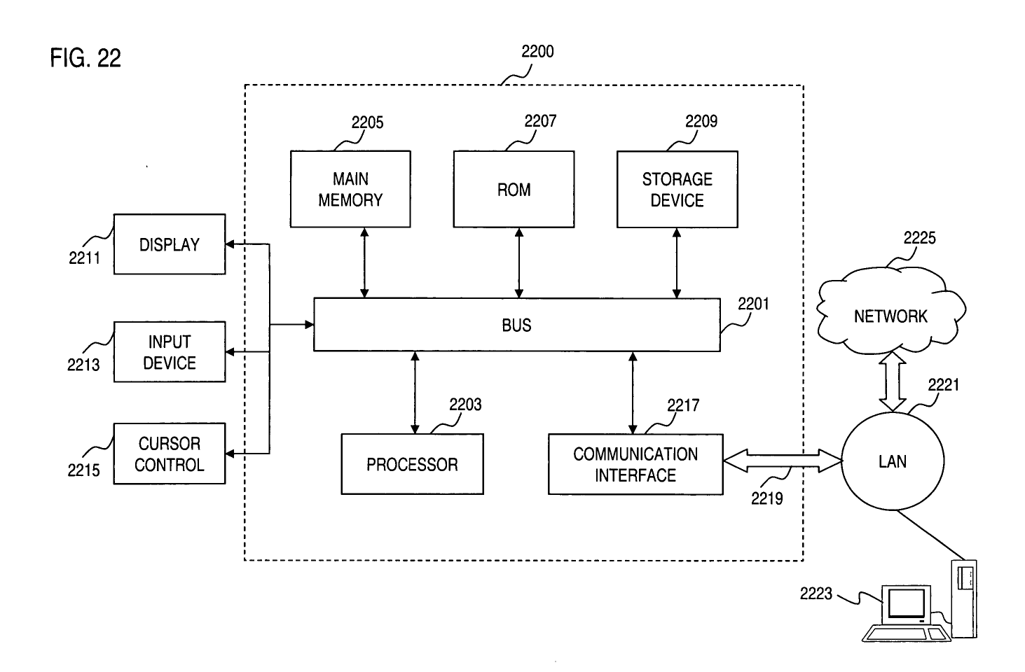

FIG. 22 illustrates a computer system 2200 upon which an embodiment according to the present invention can be implemented. For example, the client and server processes for supporting fleet and asset management can be implemented using the computer system 2200. The computer system 2200 includes a bus 2201 or other communication mechanism for communicating information and a processor 2203 coupled to the bus 2201 for processing information. The computer system 2200 also includes main memory 2205, such as a random access memory (RAM) or other dynamic storage device, coupled to the bus 2201 for storing information and instructions to be executed by the processor 2203. Main memory 2205 can also be used for storing temporary variables or other intermediate information during execution of instructions by the processor 2203. The computer system 2200 may further include a read only memory (ROM) 2207 or other static storage device coupled to the bus 2201 for storing static information and instructions for the processor 2203. A storage device 2209, such as a magnetic disk or optical disk, is coupled to the bus 2201 for persistently storing information and instructions.

The computer system 2200 may be coupled via the bus 2201 to a display 2211, such as a cathode ray tube (CRT), liquid crystal display, active matrix display, or plasma display, for displaying information to a computer user. An input device 2213, such as a keyboard including alphanumeric and other keys, is coupled to the bus 2201 for communicating information and command selections to the processor 2203. Another type of user input device is a cursor control 2215, such as a mouse, a trackball, or cursor direction keys, for communicating direction information and command selections to the processor 2203 and for controlling cursor movement on the display 2211.

According to one embodiment of the invention, the processes of the servers and clients in the system 100 of FIG. 1 are performed by the computer system 2200, in response to the processor 2203 executing an arrangement of instructions contained in main memory 2205. Such instructions can be read into main memory 2205 from another computer-readable medium, such as the storage device 2209. Execution of the arrangement of instructions contained in main memory 2205 causes the processor 2203 to perform the process steps described herein. One or more processors in a multi-processing arrangement may also be employed to execute the instructions contained in main memory 2205. In alternative embodiments, hard-wired circuitry may be used in place of or in combination with software instructions to implement the embodiment of the present invention. Thus, embodiments of the present invention are not limited to any specific combination of hardware circuitry and software.

The computer system 2200 also includes a communication interface 2217 coupled to bus 2201. The communication interface 2217 provides a two-way data communication coupling to a network link 2219 connected to a local network 2221. For example, the communication interface 2217 may be a digital subscriber line (DSL) card or modem, an integrated services digital network (ISDN) card, a cable modem, a telephone modem, or any other communication interface to provide a data communication connection to a corresponding type of communication line. As another example, communication interface 2217 may be a local area network (LAN) card (e.g. for Ethernet™ or an Asynchronous Transfer Model (ATM) network) to provide a data communication connection to a compatible LAN. Wireless links can also be implemented. In any such implementation, communication interface 2217 sends and receives electrical, electromagnetic, or optical signals that carry digital data streams representing various types of information. Further, the communication interface 2217 can include peripheral interface devices, such as a Universal Serial Bus (USB) interface, a PCMCIA (Personal Computer Memory Card International Association) interface, etc. Although a single communication interface 2217 is depicted in FIG. 22, multiple communication interfaces can also be employed.

The network link 2219 typically provides data communication through one or more networks to other data devices. For example, the network link 2219 may provide a connection through local network 2221 to a host computer 2223, which has connectivity to a network 2225 (e.g. a wide area network (WAN) or the global packet data communication network now commonly referred to as the “Internet”) or to data equipment operated by a service provider. The local network 2221 and the network 2225 both use electrical, electromagnetic, or optical signals to convey information and instructions. The signals through the various networks and the signals on the network link 2219 and through the communication interface 2217, which communicate digital data with the computer system 2200, are exemplary forms of carrier waves bearing the information and instructions.

The computer system 2200 can send messages and receive data, including program code, through the network(s), the network link 2219, and the communication interface 2217. In the Internet example, a server (not shown) might transmit requested code belonging to an application program for implementing an embodiment of the present invention through the network 2225, the local network 2221 and the communication interface 2217. The processor 2203 may execute the transmitted code while being received and/or store the code in the storage device 2209, or other non-volatile storage for later execution. In this manner, the computer system 2200 may obtain application code in the form of a carrier wave.

The term “computer-readable medium” as used herein refers to any medium that participates in providing instructions to the processor 2205 for execution. Such a medium may take many forms, including but not limited to non-volatile media, volatile media, and transmission media. Non-volatile media include, for example, optical or magnetic disks, such as the storage device 2209. Volatile media include dynamic memory, such as main memory 2205. Transmission media include coaxial cables, copper wire and fiber optics, including the wires that comprise the bus 2201. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

The following patent applications are incorporated by reference in their entireties: co-pending U.S. patent application (Attorney Docket No. 09710-1207) filed Jan. 16, 2004, entitled “Method and System for Scheduling of Data Retrieval from Mobile Telemetry Devices”; co-pending U.S. patent application (Attorney Docket No. 09710-1208) filed Jan. 16, 2004, entitled “Method and System for Tracking Mobile Telemetry Devices”; co-pending U.S. patent application (Attorney Docket No. 09710-1209) filed Jan. 16, 2004, entitled “Method and System for Remotely Configuring Mobile Telemetry Devices”; co-pending U.S. patent application (Attorney Docket No. 09710-1210) filed Jan. 16, 2004, entitled “Method and System for Mobile Telemetry Device Prioritized Messaging”; co-pending U.S. patent application (Attorney Docket No. 09710-1212) filed Jan. 16, 2004, entitled “Method and System for Transmitting Assistance Location Data for Fleet and Asset Management”; co-pending U.S. patent application (Attorney Docket No. SKY-03-003) filed Jan. 16, 2004, entitled “Method and System for Tracked Device Location and Route Adherence via Geofencing”; and co-pending U.S. patent application (Attorney Docket No. SKY-03-009) filed Jan. 16, 2004, entitled “Method and System for Secured Wireless Data Transmission to and from a Remote Device.”

While the present invention has been described in connection with a number of embodiments and implementations, the present invention is not so limited but covers various obvious modifications and equivalent arrangements, which fall within the purview of the appended claims.

1. A method for managing a plurality of tracked objects, each tracked object associated with a corresponding telemetry device, the method comprising:
receiving, from a web browser, a request for at least one action to be performed by the at least one corresponding telemetry device; and
transmitting, to the at least one corresponding telemetry device, a message including information indicating the at least one action, wherein the web browser is configured to display at least one geographical map indication of at least one location of each tracked object.

2. A method according to claim 1, wherein the at least one action includes instructing the tracked object to perform a tracked object activity.

3. A method according to claim 2, wherein the tracked object activity includes at least one of turning a vehicle ignition on, turning the vehicle ignition off, locking a door, unlocking the door, turning on a temperature control system, turning off the temperature control system, turning on a refrigerating control system, and turning off the refrigerating control system.

4. A method according to claim 1, wherein the at least one action includes obtaining data indicating at least one status of the tracked object.

5. A method according to claim 4, wherein the at least one status is obtained by an Input/Output (I/O) interface of the telemetry device.

6. A method according to claim 4, wherein the at least one status includes at least one of a GeoFence status, a location status, an ignition status of the tracked object, a locked door status of the tracked object, a battery status, a speed status, and a tracked object property status.

7. A method according to claim 1, further comprising:
receiving, from the at least one corresponding telemetry device, a message including an indication of at least one status of the corresponding tracked object; and
transmitting, to the web browser, display information including a display indicator of an alert based on the at least one status.

8. A method according to claim 1, wherein communication with the web browser includes transmission of geographic map information which is preprocessed by a server and sent in an image file with associating data to the web browser.

9. A method according to claim 1, wherein communication with the web browser includes transmission of information which is preprocessed by a servlet using a Java Object Input/Output Stream and Reflection configuration.

10. A display device for managing a plurality of tracked objects, each tracked object associated with a corresponding telemetry device, the display device comprising:
a web browser configured to process a request for at least one action to be performed by the at least one corresponding telemetry device, to display at least one geographical map indication of at least one location of each tracked object, and to transmit information for inclusion in a message, for transmission to the corresponding telemetry device, the message including information indicating the at least one action.

11. A display device according to claim 10, wherein the at least one action includes instructing the tracked object to perform a tracked object activity.

12. A display device according to claim 11, wherein the tracked object activity includes at least one of turning a vehicle ignition on, turning the vehicle ignition off, locking a door, unlocking the door, turning on a temperature control system, turning off the temperature control system, turning on a refrigerating control system, and turning off the refrigerating control system.

13. A display device according to claim 10, wherein the at least one action includes obtaining data indicating at least one status of the tracked object.

14. A display device according to claim 13, wherein the at least one status is obtained by an Input/Output (I/O) interface of the telemetry device.

15. A method according to claim 14, wherein the at least one status includes at least one of a GeoFence status, a location status, an ignition status of the tracked object, a locked door status of the tracked object, a battery status, a speed status, and a tracked object property status.

16. A display device according to claim 10, wherein the web browser is further configured to receive, from the at least one corresponding telemetry device, an indication of at least one status of the corresponding tracked object, and to display information including a display indicator of an alert based on the at least one status.

17. A display device according to claim 10, wherein communication with the web browser includes transmission of map information which is preprocessed by a server and sent in an image file with associating data to the web browser.

18. A display device according to claim 10, wherein communication with the web browser includes transmission of information which is preprocessed by a servlet using a Java Object Input/Output Stream and Reflection configuration.

19. A computer-readable medium carrying one or more sequences of one or more instructions for prioritizing transmission of messages from a telemetry device, the one or more sequences of one or more instructions including instructions which, when executed by one or more processors, cause the one or more processors to perform the steps of:
receiving, from a web browser, a request for at least one action to be performed by the at least one corresponding telemetry device; and
transmitting, to the at least one corresponding telemetry device, a message including information indicating the at least one action wherein the web browser is configured to display at least one geographical map indication of at least one location of each tracked object.

20. A computer-readable medium according to claim 19, wherein the at least one action includes instructing the tracked object to perform a tracked object activity.

21. A computer-readable medium according to claim 19, wherein the tracked object activity includes at least one of turning a vehicle ignition on, turning the vehicle ignition off, locking a door, unlocking the door, turning on a temperature control system, turning off the temperature control system, turning on a refrigerating control system, and turning off the refrigerating control system.

22. A computer-readable medium according to claim 19, wherein the at least one action includes obtaining data indicating at least one status of the tracked object.

23. A computer-readable medium according to claim 22, wherein the at least one status is obtained by an Input/Output (I/O) interface of the telemetry device.

24. A computer-readable medium according to claim 23, wherein the at least one status includes at least one of a GeoFence status, a location status, an ignition status of the tracked object, a locked door status of the tracked object, a battery status, a speed status, and a tracked object property status.

25. A computer-readable medium according to claim 19, further including instructions for causing the one or more processors to perform the steps of:
receiving, from the at least one corresponding telemetry device, a message including an indication of at least one status of the corresponding tracked object; and
transmitting, to the web browser, display information including a display indicator of an alert based on the at least one status.

26. A computer-readable medium according to claim 19, wherein communication with the web browser includes transmission of map information which is preprocessed by a server and sent in an image file with associating data to the web browser.

27. A computer-readable medium according to claim 19, wherein communication with the web browser includes transmission of information which is preprocessed by a servlet using a Java Object Input/Output Stream and Reflection configuration.

28. A method for managing a plurality of tracked objects, each tracked object associated with a corresponding telemetry device, the method comprising:
transmitting, to a user, display information for displaying interactive elements on a display device;
receiving, from the user, information associated with at least one status of at least one of the tracked objects; and
transmitting, to the telemetry device corresponding to the at least one tracked object, a message including the information associated with the at least one status,
wherein the at least one status is at least one of monitored and controlled by at least one processor included in the telemetry device corresponding to the at least one tracked object, and wherein the display device is configured to display at least one geographical map indication of at least one location of each tracked object.

29. A method according to claim 28, further comprising:
determining whether the at least one tracked object includes a status of in range of a provider; and
transmitting the message to the telemetry device corresponding to the at least one tracked object if the at least one tracked object includes a status of in range of a provider.

30. An apparatus for managing a plurality of tracked objects, each tracked object associated with a corresponding telemetry device, the apparatus comprising:
means for transmitting, to a user, display information for displaying interactive elements on a display device, wherein the display device is configured to display at least one geographical map indication of at least one location of each tracked object;
means for receiving, from the user, information associated with at least one status of at least one of the tracked objects; and
means for transmitting, to the telemetry device corresponding to the at least one tracked object, a message including the information associated with the at least one status,
wherein the at least one status is at least one of monitored and controlled by at least one processor included in the telemetry device corresponding to the at least one tracked object.

31. An apparatus according to claim 30, further comprising:
means for determining whether the at least one tracked object includes a status of in range of a provider; and
means for transmitting the message to the telemetry device corresponding to the at least one tracked object if the at least one tracked object includes a status of in range of a provider.
